(19) United States
(12) Patent Application Publication
(10) Pub. No.: US 2025/0300736 A1
(43) Pub. Date: Sep. 25, 2025

(54) TRANSMISSION DEVICE AND COMMUNICATION DEVICE

(71) Applicant: NEC Corporation, Tokyo (JP)

(72) Inventors: Masaki AIZONO, Tokyo (JP); Fujio OKUMURA, Kanagawa (JP); Atsushi KAMOI, Tokyo (JP)

(73) Assignee: NEC Corporation, Tokyo (JP)

(21) Appl. No.: 19/003,195

(22) Filed: Dec. 27, 2024

(30) Foreign Application Priority Data
Mar. 21, 2024 (JP) 2024-044452

(51) Int. Cl. H04B 10/50; H04B 10/516

(52) U.S. Cl. CPC H04B 10/501; H04B 10/516

(57) ABSTRACT

Provided is a transmission device including a light source that emits illumination light, a spatial light modulator including a modulation part irradiated with the illumination light emitted from the light source, and an annular mirror array including a plurality of concave mirrors annularly disposed with an optical axis of the illumination light as a center, and disposed at a position at which modulated light modulated by the modulation part of the spatial light modulator is reflected laterally as a spatial optical signal.

This application is based upon and claims the benefit of priority from Japanese Patent Application No. 2024-044452, filed on Mar. 21, 2024, the disclosure of which is incorporated herein in its entirety by reference.

### TECHNICAL FIELD

The present disclosure relates to a transmission device and a communication device.

### BACKGROUND ART

In optical spatial communication, communication using an optical signal (hereinafter, also referred to as a spatial optical signal) propagating in space is performed without passing through a medium such as an optical fiber. For example, when a transmission device including a phase modulation type spatial light modulator is used, the spatial optical signal can be transmitted in various directions by controlling the pattern set in the modulation part of the spatial light modulator. When the spatial optical signal can be transmitted in a plurality of directions around the transmission device, a communication network using the spatial optical signal can be constructed. In general spatial optical communication, an adjustment mechanism for adjusting a transmission/reception direction of a spatial optical signal is required in order to transmit the spatial optical signal in various directions. Therefore, when the direction of the communication target is unknown, it is necessary to visually confirm the direction of the communication target or adjust the transmission/reception direction through communication between the communication devices. As described above, it takes labor and time to install the communication device that transmits and receives the spatial optical signal.

PTL 1 (JP 2018-026095 A) discloses an optical transmission/reception device for transmitting and receiving optical signals between traveling vehicles. The device of PTL 1 includes a light emitting unit, a light reception unit, and an omnidirectional optical component. In the device of PTL 1, the optical axis on which the optical signal transmitted from the light emitting unit is incident on the optical component and the optical axis on which the optical signal transmitted from another vehicle and incident on the optical component is emitted from the optical component are the same optical axis. The device of PTL 1 transmits an optical signal in all directions in an external substantially horizontal direction through an optical component, and receives an optical signal from all directions in the substantially horizontal direction transmitted from another vehicle. In this way, the device of PTL 1 performs omnidirectional transmission and reception to and from an unspecified vehicle. The device of PTL 1 receives an optical signal transmitted from a specific another vehicle while transmitting an optical signal transmitted from one light emitting element toward the specific another vehicle through an omnidirectional optical component. In this way, the device of PTL 1 performs one-to-one communication with a specific another vehicle.

In the method of PTL 1, a communication target is detected by omnidirectional transmission and reception, and individual optical signals (individual signals) are transmitted toward a single detected communication target. In the method of PTL 1, an optical signal is transmitted via a rotating body having a curved translucent surface. Therefore, in the method of PTL 1, the beam diameter of the optical signal increases as the distance from the optical transmission/reception device increases according to the curvature of the translucent surface, and the optical signal is easily attenuated. On the other hand, in a case where the plane mirror is used instead of the curved translucent surface, attenuation of the optical signal is reduced, but a blind spot area where the optical signal cannot be transmitted increases.

An object of the present disclosure is to provide a transmission device and a communication device capable of transmitting a spatial optical signal that is hardly attenuated in an any direction along a horizontal plane.

### SUMMARY

A transmission device according to an aspect of the present disclosure includes a light source that emits illumination light, a spatial light modulator including a modulation part irradiated with the illumination light emitted from the light source, and an annular mirror array including a plurality of concave mirrors annularly disposed with an optical axis of the illumination light as a center, and disposed at a position at which modulated light modulated by the modulation part of the spatial light modulator is reflected laterally as a spatial optical signal.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmission device in the present disclosure;

FIG. 2 is a conceptual diagram illustrating an example of a configuration of a transmission device in the present disclosure;

FIG. 3 is a conceptual diagram illustrating an example of a configuration of a transmission device in the present disclosure;

FIG. 4 is a conceptual diagram illustrating an example of a plurality of modulation regions set in a modulation part of the spatial light modulator in the present disclosure;

FIG. 5 is a conceptual diagram illustrating an example of transmission of a spatial optical signal by the transmission device in the present disclosure;

FIG. 6 is a conceptual diagram illustrating an example of transmission of a spatial optical signal by the transmission device in the present disclosure;

FIG. 7 is a conceptual diagram for describing a pillar of a housing of the transmission device in the present disclosure;

FIG. 8 is a conceptual diagram illustrating an example of transmission of a spatial optical signal by the transmission device in the present disclosure;

FIG. 9 is a conceptual diagram illustrating an example of transmission of a spatial optical signal by the transmission device in the present disclosure;

FIG. 10 is a conceptual diagram illustrating an example of a configuration of a transmission device in the present disclosure;

FIG. 11 is a conceptual diagram illustrating an example of a configuration of a transmission device in the present disclosure;

FIG. 12 is a conceptual diagram illustrating an example of a configuration of a transmission device in the present disclosure;

FIG. 13 is a conceptual diagram illustrating an example of a configuration of a transmission device in the present disclosure;

FIG. 14 is a conceptual diagram illustrating an example of a configuration of a transmission device in the present disclosure;

FIG. 15 is a conceptual diagram illustrating an example of a configuration of a transmission device in the present disclosure;

FIG. 16 is a conceptual diagram illustrating an example of a configuration of a transmission device in the present disclosure;

FIG. 17 is a conceptual diagram illustrating an example of a configuration of a transmission device in the present disclosure;

FIG. 18 is a conceptual diagram illustrating an example of a configuration of a transmission device in the present disclosure;

FIG. 19 is a conceptual diagram illustrating an example of a configuration of a transmission device in the present disclosure;

FIG. 20 is a conceptual diagram illustrating an example of a configuration of a communication device in the present disclosure;

FIG. 21 is a conceptual diagram illustrating an example of a configuration of a receiver included in a communication device according to the present disclosure;

FIG. 22 is a conceptual diagram illustrating an example of a configuration of a communication device in the present disclosure;

FIG. 23 is a conceptual diagram for describing an application example in the present disclosure;

FIG. 24 is a block diagram illustrating an example of a configuration of a transmission device in the present disclosure; and

FIG. 25 is a block diagram illustrating an example of a hardware configuration that executes control and processing in the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, the transmission device according to a first example embodiment will be described with reference to the drawings. The transmission device of the present example embodiment is used for optical spatial communication in which the optical signal (hereinafter, also referred to as a spatial optical signal) propagating in space is transmitted and received. The transmission device of the present example embodiment may be used for applications other than optical spatial communication as long as the transmission device is used for transmitting light propagating in a space. The drawings used in the description of the present example embodiment are conceptual and do not accurately depict an actual structure.

### Configuration

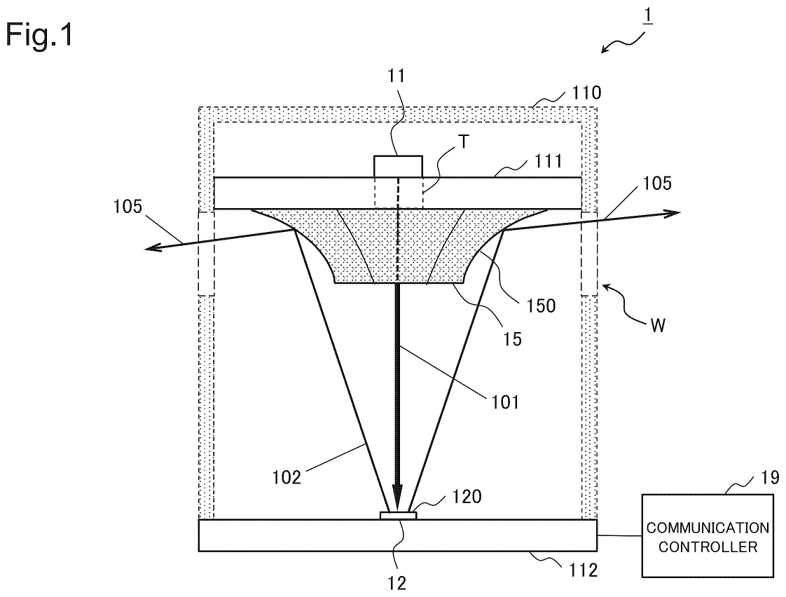

FIG. 1 to FIG. 3 are conceptual diagrams illustrating an example of a configuration of a transmission device in the present disclosure. A transmission device 1 includes a light source 11, a spatial light modulator 12, an annular mirror array 15, and a communication controller 19. The light source 11, the spatial light modulator 12, and the annular mirror array 15 constitute a transmitter. The transmitter is accommodated inside a housing 110 in which a window W for transmitting a spatial optical signal is formed.

FIG. 1 is a conceptual diagram of an internal configuration of a transmission device in the present disclosure when viewed from a side. FIG. 1 illustrates the housing 110 cut along a cutting line passing through the window W. FIG. 1 is conceptual, and does not accurately represent a shape of each component, a positional relationship between components, traveling of light, and the like. The configuration of FIG. 1 may be disposed in a state where the upper and lower sides are inverted. FIG. 1 illustrates a top plate 111 that supports the light source 11 and the annular mirror array 15. FIG. 1 illustrates a bottom plate 112 on which the spatial light modulator 12 is disposed.

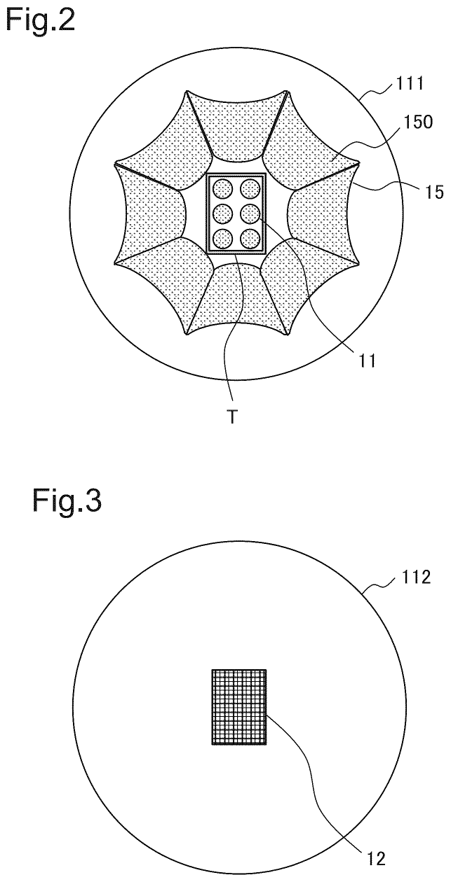

FIG. 2 is a conceptual diagram of the top plate of the transmission device in the present disclosure when viewed from below. The through hole T is opened at the center of the top plate 111. The through hole T is an opening for allowing illumination light 101 emitted from the light source 11 to pass downward. In the example of FIG. 2, the opening shape of the through hole Tis rectangular, but the opening shape of the through hole T may not be rectangular. The annular mirror array 15 is disposed on the lower face of the top plate 111. The annular mirror array 15 is a mirror array in which a plurality of concave mirrors is annularly disposed. The plurality of concave mirrors constituting the annular mirror array 15 is annularly disposed around the optical axis of the illumination light 101 emitted from the light source 11. The reflection surfaces 150 of the plurality of concave mirrors constituting the annular mirror array 15 are all directed in different directions.

FIG. 3 is a conceptual diagram of the bottom plate of the transmission device in the present disclosure when viewed from above. The spatial light modulator 12 is disposed at the center of the bottom plate 112. A modulation part 120 of the spatial light modulator 12 is directed to the light source 11.

The light source 11 emits the illumination light 101. The emission face of the light source 11 is directed to the modulation part 120 of the spatial light modulator 12 via the through hole T of the top plate 111. The light source 11 may be disposed inside the through hole T of the top plate 111. The light source 11 may be disposed on the lower face of the top plate 111 or between the top plate 111 and the spatial light modulator 12. In this case, the through hole T may not be formed in the top plate 111. The modulation part 120 of the spatial light modulator 12 is irradiated with the illumination light 101 emitted from the light source 11 passes through the through hole T.

The light source 11 includes a plurality of emitters (not illustrated). An emitter included in the light source 11 emits laser light in a predetermined wavelength band under the control of the communication controller 19. The wavelength of the laser light emitted from the emitter is not particularly limited, and may be selected according to the application. For example, the emitter emits the laser light in the visible or infrared wavelength band. For example, in the case of near infrared rays of 800 to 1000 nanometers (nm), since the laser class can be increased as compared with visible light, the sensitivity can be improved as compared with visible light. For example, a laser light source having a higher output can be used for infrared rays in a wavelength band of 1.55 micrometers (μm) than near infrared rays of 800 to 1000 nm. As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. The light source 11 may be achieved by a face emitting laser. The light source 11 is achieved by a photonic crystal surface emitting laser (PCSEL) type laser. Since the PCSEL type laser emits laser light of circular narrow radiation, a collimator is unnecessary.

The spatial light modulator 12 is a phase modulation type spatial light modulator. The spatial light modulator 12 includes the modulation part 120. A plurality of modulation regions is set in the modulation part 120. For example, the number of modulation regions set in the modulation part 120 is set in accordance with the number of emitters included in the light source 11.

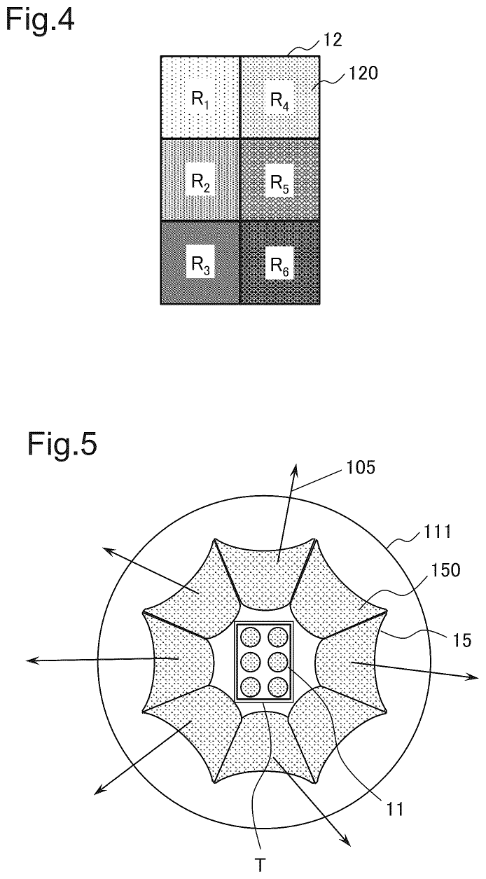

FIG. 4 is a conceptual diagram illustrating an example of a plurality of modulation regions set in a modulation part of the spatial light modulator in the present disclosure. For example, in the modulation part 120, the modulation region R is set according to the number of emitters included in the light source 11. The number of modulation regions R set in the modulation part 120 is set in any number. In the example of FIG. 4, six modulation regions R (R₁ to R₆) are set. A dead zone may be set between the adjacent modulation regions R. For example, a black lattice shaped phase image is set in the dead zone. The dead zone may be set in any shape instead of the lattice shape of modulation part 120. Normally, a composite image obtained by combining a phase image and a virtual lens image for forming a desired image is set in the modulation part 120. The virtual lens image is a pattern for forming a desired image at a position of a desired distance. Modulated light 102 modulated by the modulation part 120 is focused on a position at a desired distance by the virtual lens image. For example, when a virtual lens image that brings about the action of a cylindrical lens is used, linear projection light 105 can be projected. Since the linear projection light 105 can concentrate energy, the projection light 105 can be projected far away.

Each of the plurality of modulation regions R is associated with any of the plurality of emitters included in the light source 11. A pattern (also referred to as a phase image) related to the image displayed by the projection light 105 is set in each of the plurality of modulation regions R under the control of the communication controller 19. Each of the plurality of modulation regions R is irradiated with the illumination light 101. The illumination light 101 is derived from the laser light emitted from the emitter associated with the modulation region R. The illumination light 101 incident on each of the plurality of modulation regions R is modulated according to a pattern (phase image) set in each of the plurality of modulation regions R. The modulated light 102 modulated in each of the plurality of modulation regions R travels toward the reflection surface 150 of the annular mirror array 15.

The modulation region R is divided into a plurality of regions (also referred to as tiling). For example, the modulation region R is divided into square or rectangular regions (also referred to as tiles). Each of the plurality of tiles includes a plurality of pixels. A phase image related to the image to be projected is set to each of the plurality of tiles. The same phase image is tiled to each of the plurality of tiles allocated to the modulation region R. For example, a phase image generated in advance is set in each of the plurality of tiles. When the modulation region R is irradiated with the illumination light 101 in a state in which the same phase image is set to the plurality of tiles, the modulated light 102 that forms an image related to the phase image is emitted. As the number of tiles set in the modulation region R increases, a clear image can be displayed. On the other hand, when the number of pixels of each tile decreases, the resolution decreases. Therefore, the size and the number of tiles set in the modulation region R are set according to the application.

For example, the spatial light modulator 12 is achieved by a spatial light modulator using ferroelectric liquid crystal, homogeneous liquid crystal, vertical alignment liquid crystal, or the like. For example, the spatial light modulator 12 can be achieved by liquid crystal on silicon (LCOS). The spatial light modulator 12 may be achieved by a micro electro mechanical system (MEMS). In the phase modulation type spatial light modulator 12, the energy can be concentrated on the portion of the image by operating to sequentially switch the portion on which the projection light 105 is projected. Therefore, in the case of using the phase modulation type spatial light modulator 12, when the outputs of the emitters included in the light source 11 are the same, the image can be displayed brighter than other methods.

The modulated light 102 modulated by the modulation part 120 of the spatial light modulator 12 travels toward the reflection surface 150 of the annular mirror array 15. The modulated light 102 traveling toward the reflection surface 150 of the annular mirror array 15 is reflected by the reflection surface 150 and projected as the projection light 105.

The annular mirror array 15 has a configuration in which a plurality of concave mirrors is disposed in an annular shape. The concave mirror is a concave mirror having a concave reflection surface 150. The reflection surface 150 of the concave mirror is formed of a free-form surface. Arranging a plurality of concave mirrors in an annular shape can cover a wide in a smaller number range than arranging a plurality of plane mirrors in an annular shape. The eight concave mirrors constituting the annular mirror array 15 are annularly disposed with their reflection surfaces 150 facing obliquely downward. The number of concave mirrors constituting the annular mirror array 15 is not limited to 8.

The annular mirror array 15 is irradiated with a light component to be projected (also referred to as desired light) of the modulated light 102 modulated by the modulation part 120 of the spatial light modulator 12. The modulated light 102 with which the reflection surface 150 is irradiated is reflected by the reflection surface 150. The light (projection light 105) reflected by the reflection surface 150 is projected as a spatial optical signal. The reflection surface 150 of the annular mirror array 15 is directed in a 360 degree orientation in the horizontal plane. Therefore, the transmission device 1 can project the projection light 105 in a 360 degree orientation in the horizontal plane by controlling the pattern (phase image) set in the modulation part 120 of the spatial light modulator 12. The projection light 105 is projected in a direction along the horizontal plane. The traveling axis of the projection light 105 may be along the horizontal plane and may not be completely parallel to the horizontal plane.

FIG. 5 is a conceptual diagram illustrating an example of transmission of a spatial optical signal by the transmission device in the present disclosure. FIG. 5 is a conceptual diagram illustrating an example in which illumination light radiated by a plurality of emitters included in a light source is reflected by different concave mirrors to transmit spatial optical signals in a plurality of directions. FIG. 5 is a diagram of the top plate when viewed from below. The transmission device 1 can simultaneously transmit the spatial optical signal (projection light 105) toward the communication targets disposed in the plurality of directions by associating the plurality of modulation regions R set in the modulation part 120 with the different concave mirrors. For example, in a mode for communicating with a plurality of communication targets, the transmission device 1 associates the plurality of modulation regions R set in the modulation part 120 with different concave mirrors. With such association, the transmission device 1 can individually transmit the spatial optical signal toward each of the plurality of communication targets located in the plurality of directions.

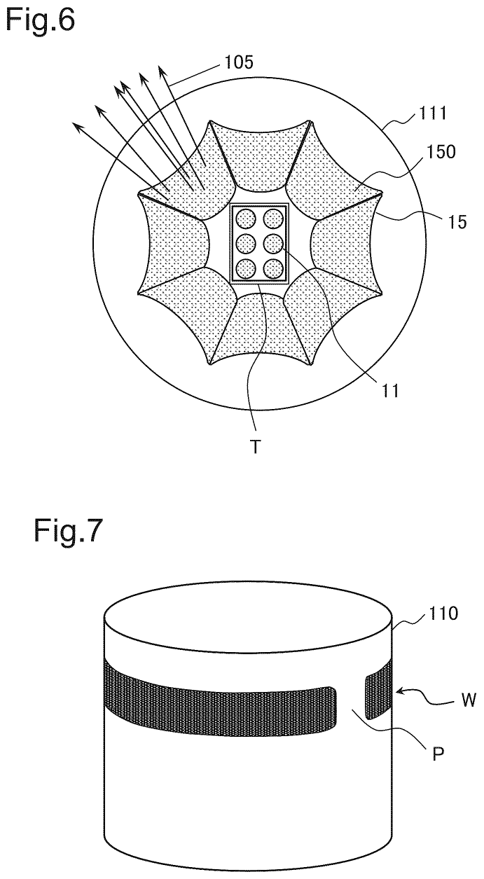

FIG. 6 is a conceptual diagram illustrating an example of transmission of a spatial optical signal by the transmission device in the present disclosure. FIG. 6 is a conceptual diagram illustrating an example in which modulated light derived from illumination light radiated by a plurality of emitters included in a light source is reflected by a single concave mirror to transmit a spatial optical signal in one direction. FIG. 6 is a diagram of the top plate when viewed from below. For example, in a mode for searching for a communication target, the transmission device 1 associates a plurality of modulation regions R set in the modulation part 120 with a single concave mirror. With such association, the transmission device 1 can transmit the spatial optical signal configured by the plurality of light fluxes toward the reflection direction of the reflection surface of the concave mirror. According to the transmission control as illustrated in FIG. 6, the probability that the light flux strikes the communication target increases by transmitting the spatial optical signal configured by the plurality of light fluxes, and the detection speed of the communication target is improved. The transmission device 1 may be controlled to transmit the multiplexed spatial optical signal (projection light 105) toward a single communication target. When transmitting the multiplexed spatial optical signal, the transmission device 1 sets, in the modulation part 120 of the spatial light modulator 12, a phase image in which part of the reflection surface of the concave mirror is irradiated with the modulated light 102 derived from the illumination light 101. In this way, the multiplexed spatial optical signal can be transmitted toward a single communication target.

The communication controller 19 controls the light source 11 and the spatial light modulator 12. For example, the communication controller 19 is achieved by a microcomputer including a processor and a memory. The communication controller 19 sets a phase image related to the image to be projected in the modulation part 120. The communication controller 19 sets a phase image related to the image to be projected in the modulation region set in the modulation part 120 of the spatial light modulator 12. The phase image of the image to be projected may be stored in advance in a storage unit (not illustrated). The shape and the size of the image to be projected are not particularly limited.

The communication controller 19 controls the spatial light modulator 12 in such a way that a parameter that determines a difference between a phase of the illumination light 101 with which the modulation part 120 is irradiated and a phase of the modulated light 102 reflected by the modulation part 120 changes. The driving method of the spatial light modulator 12 by the communication controller 19 is determined according to the modulation scheme of the spatial light modulator 12. The communication controller 19 drives the light source 11 in a state in which the phase image related to the image to be displayed is set in the modulation part 120 of the spatial light modulator 12. As a result, in a state in which the phase image is set in the modulation part 120, the modulation part 120 is irradiated with the illumination light 101 emitted from light source 11. The illumination light 101 with which the modulation part 120 is irradiated is modulated by the modulation part 120.

The communication controller 19 modulates the illumination light 101 emitted from the light source 11 for communication with a communication target (not illustrated). In communication, the communication controller 19 controls the timing at which the illumination light 101 is emitted from the light source 11 in a state where the communication phase image is set in the modulation part 120 of the spatial light modulator 12. By such control, the illumination light 101 is modulated. The modulation pattern of the illumination light 101 in the communication is set in any pattern.

### Transmission Example

Next, an example of transmission of a spatial optical signal by the transmission device 1 of the present example embodiment will be described with reference to the drawings. An example in which the spatial optical signal is transmitted while avoiding the pillar of the housing 110 will be described.

FIG. 7 is a conceptual diagram for describing a pillar of a housing of the transmission device in the present disclosure. FIG. 7 is a diagram of the housing in the present disclosure when viewed from obliquely above. A pillar P for fixing an upper portion and a lower portion of the housing 110 is installed in a portion where the window W is formed in the housing 110. For example, wiring for supplying electricity to a component requiring electricity is disposed on the pillar P.

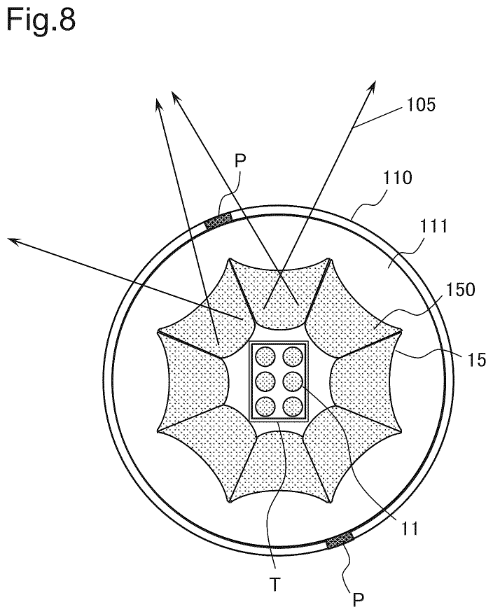

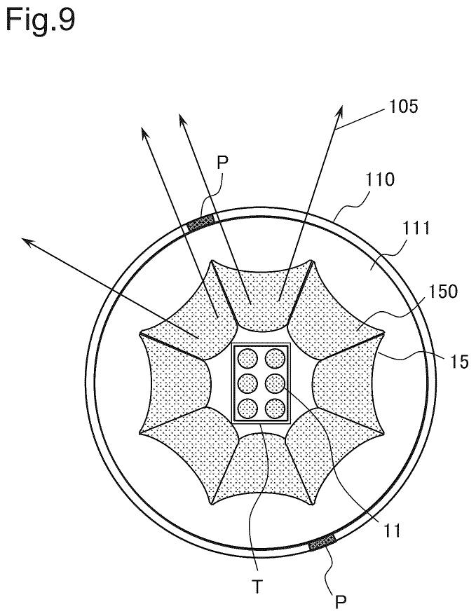

FIG. 8 to FIG. 9 are conceptual diagrams illustrating an example of transmission of a spatial optical signal by the transmission device in the present disclosure. FIG. 8 to FIG. 9 are diagrams of the top plate of the transmission device in the present disclosure when viewed from below. In the normal projection control, part of the light reflected by the reflection surface 150 of the annular mirror array 15 is shielded by the pillar P. FIG. 8 illustrates an example in which the projection light 105 reflected by the same reflection surface 150 is crossed to avoid the pillar P. FIG. 9 illustrates an example in which the pillar P can be avoided even when the projection direction of the projection light 105 reflected by the same reflection surface 150 is enlarged. As illustrated in FIG. 9, in order to enlarge the projection direction of the projection light 105, it is preferable that a plurality of concave mirrors is disposed in such a way that a joint between two concave mirrors adjacent to each other overlaps the position of pillar P.

### Modifications

Next, the modification of the present example embodiment will be described with reference to the drawings. The present modification includes a photodetector that monitors power of a spatial optical signal.

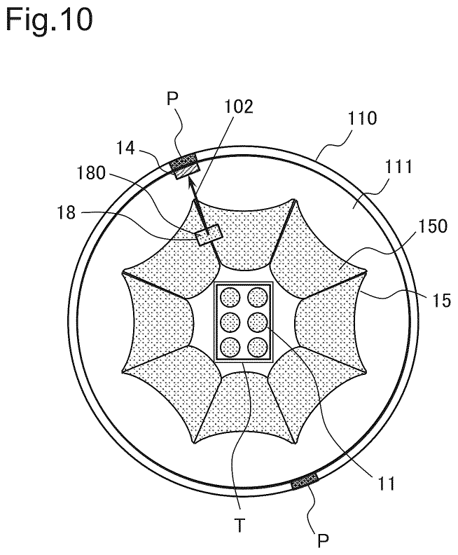

FIG. 10 is a conceptual diagram illustrating an example of a configuration of a transmission device in the present disclosure. FIG. 10 is a conceptual diagram of the top plate of the transmission device in the present disclosure when viewed from below. FIG. 10 is a cross-sectional view of the transmission device 1 taken along a cross section passing through the pillar. A photodetector 14 is disposed at the inner side of the pillar P. The photodetector 14 is configured to be irradiated with the modulated light 102 derived from the laser light emitted from all the emitters included in light source 11. The photodetector 14 is configured to monitor the modulated light 102 derived from the laser light emitted from each of the plurality of emitters included in the light source 11. A detection mirror 18 that reflects the modulated light 102 modulated by the modulation part 120 of the spatial light modulator 12 to the light reception unit of the photodetector 14 is disposed in association with the pillar P. In a case where the photodetector 14 is configured to receive the modulated light 102 reflected by the reflection surface 150 of the annular mirror array 15, the detection mirror 18 can be omitted. Hereinafter, an optical power measuring mode for monitoring the power of the spatial optical signal will be described.

In the optical power measuring mode, at least any one of the plurality of emitters included in the light source 11 is a measurement target of optical power. The modulated light 102 for measuring optical power is reflected by the reflection surface 180 of detection mirror 18 and the photodetector 14 is irradiated with the modulated light 102. he photodetector 14 converts the modulated light 102 with which the photodetector 14 is irradiated into an electric signal. The electric signal converted by the photodetector 14 is output to the communication controller 19. The communication controller 19 measures optical power of the modulated light 102 based on the electric signal output from the photodetector 14.

The photodetector 14 is a light receiving element that receives light in a wavelength region of the modulated light 102 to be measured for optical power. For example, the photodetector 14 has sensitivity to light in the visible region. For example, the photodetector 14 has sensitivity to light in an infrared region. The photodetector 14 is sensitive to light having a wavelength in a 1.5 μm (micrometer) band, for example. The wavelength band of light to which the photodetector 14 has sensitivity is not limited to the 1.5 μm band. The wavelength band of the light received by the photodetector 14 can be set to any band in accordance with the wavelength of the spatial optical signal to be received. The wavelength band of the light received by the photodetector 14 may be set to, for example, a 0.8 μm band, a 1.55 μm band, or a 2.2 μm band. The wavelength band of the light received by the photodetector 14 may be, for example, a band of 0.8 to 1 μm.

For example, the photodetector 14 can be achieved by an element such as a photodiode or a phototransistor. For example, the photodetector 14 is achieved by an avalanche photodiode. The photodetector 14 may be achieved by an element other than a photodiode, a phototransistor, or an avalanche photodiode as long as an optical signal can be converted into an electric signal.

In the optical power measuring mode, the communication controller 19 actually measures the light intensity of the spatial optical signal (projection light 105). The timing of transition to the optical power measuring mode is set in any timing. In the optical power measuring mode, the communication controller 19 sets a pattern (phase image) for emitting the modulated light 102 in the direction of the detection mirror 18 in the modulation part 120 of the spatial light modulator 12. The communication controller 19 measures the optical power of the modulated light 102 using the electric signal output from the photodetector 14 in response to the radiation of the modulated light 102. The communication controller 19 adjusts the output of the light source 11 according to the measured optical power. For example, the communication controller 19 adjusts the output of the light source 11 in such a way as to fall within a preset output range. The output range of the light source 11 is not particularly limited. For example, the output range of the light source 11 is set according to a standard defined by law. As described above, when the photodetector 14 is disposed at the inner side of the pillar P, the space inside the pillar P that can be a useless space can be effectively used.

As described above, the transmission device of the present example embodiment includes the light source, the spatial light modulator, the annular mirror array, and the communication controller. The light source emits illumination light. The spatial light modulator includes the modulation part that is irradiated with the illumination light emitted from the light source. The annular mirror array includes a plurality of concave mirrors annularly disposed around the optical axis of the illumination light. The annular mirror array is disposed at a position at which the modulated light modulated by the modulation part of the spatial light modulator is reflected laterally as a spatial optical signal. The communication controller sets a phase image used for spatial optical communication in the modulation part of the spatial light modulator. The communication controller controls the light source in such a way that the modulation part to which the phase image is set is irradiated with the illumination light.

The transmission device of the present example embodiment includes an annular mirror array including a plurality of concave mirrors. Since the annular mirror array includes concave mirrors each having a reflection surface having a larger radius of curvature than an annular mirror constituted by one reflection surface, it is possible to suppress the spread of the projection angle in the horizontal plane. Since the annular mirror array includes concave mirrors each having a reflection surface having a large radius of curvature, it is possible to suppress the spread of the projection angle as compared with an annular mirror array including a plurality of plane mirrors. That is, according to the transmission device of the present example embodiment, it is possible to transmit a spatial optical signal that is hardly attenuated in an any direction along the horizontal plane.

In an aspect of the present example embodiment, the light source includes a plurality of emitters. The communication controller sets a plurality of modulation regions in the modulation part of the spatial light modulator in association with the plurality of emitters. In the mode for searching for a communication target, the communication controller sets a phase image in which a single concave mirror among a plurality of concave mirrors constituting the annular mirror array is irradiated with modulated light modulated in a plurality of modulation regions in the modulation part of the spatial light modulator. That is, in the present aspect, in the mode for searching for a communication target, the modulated light modulated in a plurality of modulation regions is transmitted as a spatial optical signal by a single concave mirror. According to the present aspect, the detection accuracy of the communication target located in the reflection direction of the reflection surface of the concave mirror is improved by searching for the communication target using the spatial optical signal configured by the plurality of light fluxes.

A communication controller according to an aspect of the present example embodiment associates each of a plurality of concave mirrors constituting an annular mirror array with any of a plurality of communication targets. The communication controller sets, in the modulation part of the spatial light modulator, a phase image in which each of the concave mirrors associated with any of the plurality of communication targets is irradiated with modulated light modulated in any of the plurality of modulation regions. That is, in the present aspect, the modulated light modulated in each of the plurality of modulation regions is transmitted as a spatial optical signal by each of the plurality of concave mirrors. According to the present aspect, it is possible to simultaneously communicate with a plurality of communication targets using the spatial optical signal for each communication target.

A communication controller according to an aspect of the present example embodiment associates at least any one of the plurality of concave mirrors constituting an annular mirror array with a single communication target in a mode for communicating with the communication target. The communication controller sets, in the modulation part of the spatial light modulator, a phase image in which a concave mirror associated with a single communication target is irradiated with modulated light modulated in a plurality of modulation regions. That is, in the present aspect, the modulated light modulated in a plurality of modulation regions is transmitted as a spatial optical signal by a single concave mirror. According to the present aspect, spatially multiplexed communication can be achieved by simultaneously transmitting a plurality of spatial optical signals to a single communication target.

A transmission device according to an aspect of the present example embodiment includes a photodetector disposed at a side of any of a plurality of concave mirrors constituting an annular mirror array. In the optical power measuring mode, the communication controller sets, in the spatial light modulator, a phase image in which the photodetector is irradiated with the modulated light modulated by the modulation part of the spatial light modulator. The communication controller measures optical power of the modulated light detected by the photodetector. The communication controller adjusts the output of the light source according to the measured optical power of the modulated light. According to the present aspect, the output of the light source can be adjusted according to the optical power of the actually emitted illumination light.

### Second Example Embodiment

Next, the transmission device according to a second example embodiment will be described with reference to the drawings. A transmission device of the present example embodiment is different from the transmission device of the first example embodiment in that a relay mirror that returns modulated light modulated by a modulation part of a spatial light modulator is included.

### Configuration

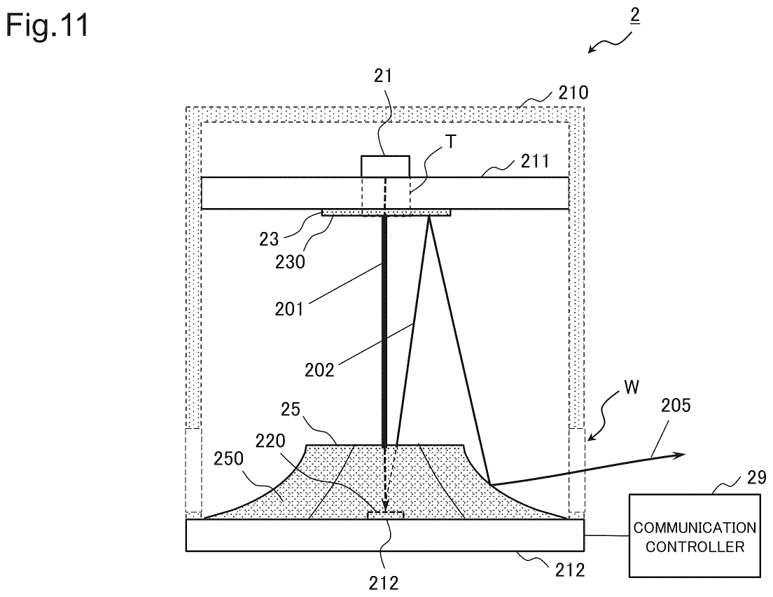

FIG. 11 to FIG. 13 are conceptual diagrams illustrating an example of a configuration of a transmission device in the present disclosure. A transmission device 2 includes a light source 21, a spatial light modulator 22, a relay mirror 23, an annular mirror array 25, and a communication controller 29. The light source 21, the spatial light modulator 22, the relay mirror 23, and the annular mirror array 25 constitute a transmitter. The transmitter is accommodated inside a housing 210 in which the window W for transmitting a spatial optical signal is formed.

FIG. 11 is a diagram of the internal configuration of the transmission device in the present disclosure when viewed from a side. FIG. 11 illustrates the housing 210 cut along a cutting line passing through the window W. FIG. 11 is conceptual, and does not accurately represent the shape of each component, the positional relationship between components, the travel of light, and the like. The configuration of FIG. 11 may be disposed in a state where the upper and lower sides are inverted. FIG. 11 illustrates a top plate 211 that supports the light source 21 and the relay mirror 23. FIG. 11 illustrates a bottom plate 212 on which the spatial light modulator 22 and the annular mirror array 25 are disposed.

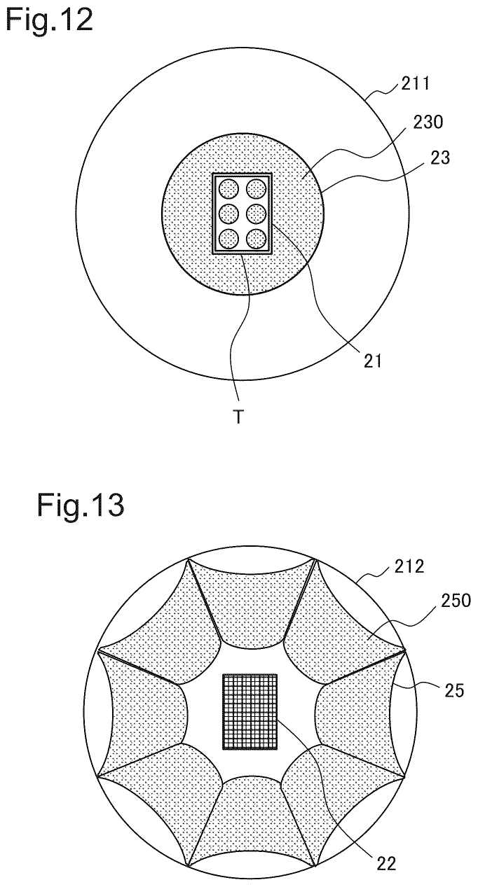

FIG. 12 is a conceptual diagram of the top plate of the transmission device in the present disclosure when viewed from below. The through hole Tis opened at the center of the top plate 211. The through hole T is an opening for allowing illumination light 201 emitted from the light source 21 to pass downward. In the example of FIG. 12, the opening shape of the through hole T is rectangular, but the opening shape of the through hole T may not be rectangular. The relay mirror 23 is disposed on a lower face of the top plate 211. The relay mirror 23 is a disk-shaped plane mirror.

FIG. 13 is a conceptual diagram of the bottom plate of the transmission device in the present disclosure when viewed from above. The spatial light modulator 22 and the annular mirror array 25 are disposed on the upper face of the bottom plate 212. The spatial light modulator 22 is disposed at the central portion of the upper face of the bottom plate 212. A modulation part 220 of the spatial light modulator 22 is directed to the light source 21. The annular mirror array 25 is disposed in such a way as to surround the periphery of the spatial light modulator 22. The annular mirror array 25 is a mirror array in which a plurality of concave mirrors is annularly disposed. The plurality of concave mirrors constituting the annular mirror array 25 is annularly disposed around the optical axis of the illumination light 201 emitted from the light source 21. The reflection surfaces 250 of the plurality of concave mirrors constituting the annular mirror array 25 are all directed in different directions.

The light source 21 has a configuration similar to that of the light source 11 of the first example embodiment. The light source 21 emits the illumination light 201. The emission face of the light source 21 is directed to the modulation part 220 of the spatial light modulator 22 via the through hole T of the top plate 211. The light source 21 may be disposed inside the through hole T. The light source 21 may be disposed on the lower face of the top plate 211 or between the top plate 211 and the spatial light modulator 22. In this case, the through hole T may not be formed in the top plate 211. The illumination light 201 emitted from the light source 21 passes through the through hole T and the modulation part 220 of the spatial light modulator 22 is irradiated with the illumination light.

The spatial light modulator 22 has a configuration similar to that of the spatial light modulator 12 of the first example embodiment. The spatial light modulator 22 is a phase modulation type spatial light modulator. The spatial light modulator 22 includes the modulation part 220. A plurality of modulation regions is set in the modulation part 220. A pattern (also referred to as a phase image) related to the image displayed by the projection light 205 is set in each of the plurality of modulation regions under the control of the communication controller 29. Each of the plurality of modulation regions is irradiated with the illumination light 201 derived from laser light emitted from an emitter associated with the modulation region. The illumination light 201 incident on each of the plurality of modulation regions set in the modulation part 220 is modulated according to a pattern (phase image) set in each of the plurality of modulation regions. The modulated light 202 modulated in each of the plurality of modulation regions travels toward the reflection surface 230 of the relay mirror 23.

The relay mirror 23 is a plane mirror formed in a disk shape with the center point of the top plate 211 as the center. The through hole T is opened in the relay mirror 23. The reflection surface 230 of the relay mirror 23 faces the upper face of the bottom plate 212 disposed below. The reflection surface 230 of the relay mirror 23 is irradiated with the modulated light 202 modulated by the modulation part 220 of the spatial light modulator 22. The modulated light 202 with which the reflection surface 230 of the relay mirror 23 is irradiated is reflected by the reflection surface 250 and travels toward the reflection surface 250 of the annular mirror array 25.

The annular mirror array 25 has a configuration similar to that of the annular mirror array 15 of the first example embodiment. The annular mirror array 25 has a configuration in which a plurality of concave mirrors is disposed in an annular shape. The reflection surface 250 of the concave mirror is formed of a free-form surface. Arranging a plurality of concave mirrors in an annular shape can cover a wide in a smaller number range than arranging a plurality of plane mirrors in an annular shape. The eight concave mirrors constituting the annular mirror array 25 are annularly disposed with their reflection surfaces 250 facing obliquely downward. The number of concave mirrors constituting the annular mirror array 25 is not limited to 8.

The modulated light 202 with which the reflection surface 250 of the annular mirror array 25 is irradiated is reflected by the reflection surface 250. The light (projection light 205) reflected by the reflection surface 250 is projected as a spatial optical signal. The reflection surface 250 of the annular mirror array 25 is directed in a 360 degree orientation in the horizontal plane. Therefore, the transmission device 2 can project the projection light 205 in a 360 degree orientation in the horizontal plane by controlling the pattern (phase image) set in the modulation part 220 of the spatial light modulator 22. The projection light 205 is projected in a direction along the horizontal plane. The traveling axis of the projection light 205 may be along the horizontal plane and may not be completely parallel to the horizontal plane.

The communication controller 29 has a configuration similar to that of the communication controller 19 of the first example embodiment. The communication controller 29 controls the light source 21 and the spatial light modulator 22. For example, the communication controller 29 is achieved by a microcomputer including a processor and a memory. The communication controller 29 sets a phase image related to the image to be projected in the modulation part 220. The communication controller 29 sets a phase image related to the image to be projected in the modulation region set in the modulation part 220 of the spatial light modulator 22. The phase image of the image to be projected may be stored in advance in a storage unit (not illustrated). The shape and the size of the image to be projected are not particularly limited.

The communication controller 29 controls the spatial light modulator 22 in such a way that a parameter that determines a difference between a phase of the illumination light 201 with which the modulation part 220 is irradiated and a phase of the modulated light 202 reflected by the modulation part 220 changes. The driving method of the spatial light modulator 22 by the communication controller 29 is determined according to the modulation scheme of the spatial light modulator 22. The communication controller 29 drives the light source 21 in a state in which the phase image related to the image to be displayed is set in the modulation part 220 of the spatial light modulator 22. As a result, with the phase image set in the modulation part 220, the modulation part 220 is irradiated with the illumination light 201 emitted from light source 21. The illumination light 201 with which the modulation part 220 is irradiated is modulated by the modulation part 220.

The communication controller 29 modulates the illumination light 201 emitted from the light source 21 for communication with a communication target (not illustrated). In communication, the communication controller 29 controls the timing at which the illumination light 201 is emitted from the light source 21 in a state where the communication phase image is set in the modulation part 220 of the spatial light modulator 22. By such control, the illumination light 201 is modulated. The modulation pattern of the illumination light 201 in the communication is set in any pattern.

As described above, the transmission device of the present example embodiment includes the light source, the spatial light modulator, the relay mirror, the annular mirror array, and the communication controller. The light source emits illumination light. The spatial light modulator includes the modulation part that is irradiated with the illumination light emitted from the light source. The relay mirror is disposed in the optical path of the modulated light emitted from the modulation part of the spatial light modulator. The relay mirror has a planar reflection surface that relay-reflects the modulated light toward the annular mirror array. The annular mirror array includes a plurality of concave mirrors annularly disposed around the optical axis of the illumination light. The annular mirror array is disposed at a position at which the modulated light relay-reflected by the reflection surface of the relay mirror is reflected laterally as a spatial optical signal. The communication controller sets a phase image used for spatial optical communication in the modulation part of the spatial light modulator. The communication controller controls the light source in such a way that the modulation part to which the phase image is set is irradiated with the illumination light.

The transmission device of the present example embodiment reflects the modulated light modulated by the modulation part of the spatial light modulator toward the reflection surface of the concave mirror constituting the annular mirror array via the reflection surface of the relay mirror. The larger the concave mirror constituting the annular mirror array, the smaller the deviation of the irradiation position of the spatial optical signal due to the processing error of the concave mirror. That is, as the annular mirror array is larger, the irradiation position accuracy of the spatial optical signal is improved. As the annular mirror array is larger, the projection light whose angle formed by the vertical axis with respect to the modulation part of the spatial light modulator and the modulated light is large increases. The larger the angle formed by the vertical axis with respect to the modulation part of the spatial light modulator and the modulated light that the projection light has, the smaller the transmission power is. When the annular mirror array and the spatial light modulator are disposed apart from each other, an angle formed by a vertical axis with respect to the modulation part of the spatial light modulator and the modulated light can be reduced. However, such a configuration increases the size of the device. According to the transmission device of the present example embodiment, the distance between the annular mirror array and the spatial light modulator can be increased by repeatedly reflecting the modulated light by the relay mirror. According to the transmission device of the present example embodiment, it is possible to reduce an increase in size of the device by repeatedly reflecting the modulated light by the relay mirror. Therefore, according to the present aspect, the irradiation position accuracy of the spatial optical signal can be improved without increasing the size of the device.

### Third Example Embodiment

Next, the transmission device according to a third example embodiment will be described with reference to the drawings. A transmission device of the present example embodiment is different from the transmission devices of the first to second example embodiments in that a plurality of relay mirrors that returns modulated light modulated by a modulation part of a spatial light modulator is included.

### Configuration

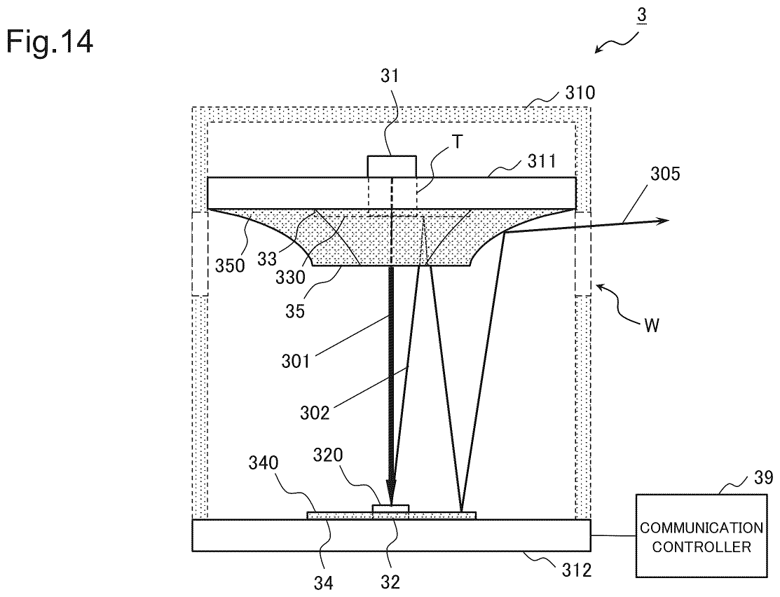

FIG. 14 to FIG. 16 are conceptual diagrams illustrating an example of a configuration of a transmission device in the present disclosure. A transmission device 3 includes a light source 31, a spatial light modulator 32, a relay mirror 33, an annular relay mirror 34, an annular mirror array 35, and a communication controller 39. The light source 31, the spatial light modulator 32, the relay mirror 33, the annular relay mirror 34, and the annular mirror array 35 constitute a transmitter. The transmitter is accommodated in a housing 310 in which the window W for transmitting a spatial optical signal is formed.

FIG. 14 is a diagram of the internal configuration of the transmission device in the present disclosure when viewed from a side. FIG. 14 illustrates the housing 310 cut along a cutting line passing through the window W. FIG. 14 is conceptual, and does not accurately represent the shape of each component, the positional relationship between components, the travel of light, and the like. The configuration of FIG. 14 may be disposed in a state where the upper and lower sides are inverted. FIG. 14 illustrates a top plate 311 that supports the light source 31, the relay mirror 33, and the annular mirror array 35. FIG. 14 illustrates a bottom plate 312 on which the spatial light modulator 32 and the annular relay mirror 34 are disposed.

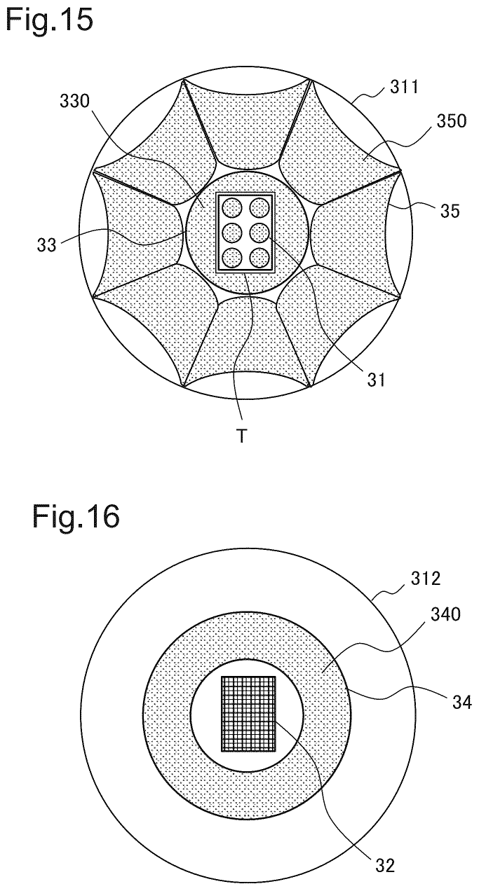

FIG. 15 is a conceptual diagram of the top plate of the transmission device in the present disclosure when viewed from below. The through hole Tis opened at the center of the top plate 311. The through hole T is an opening for allowing illumination light 301 emitted from the light source 31 to pass downward. In the example of FIG. 15, the opening shape of the through hole Tis rectangular, but the opening shape of the through hole T may not be rectangular. The relay mirror 33 and the annular mirror array 35 are disposed on the lower face of the top plate 311. The relay mirror 33 is a disk-shaped plane mirror. The annular mirror array 35 is a mirror array in which a plurality of concave mirrors is annularly disposed. The relay mirror 33 and the annular mirror array 35 are disposed concentrically. The plurality of concave mirrors constituting the annular mirror array 35 is annularly disposed around the optical axis of the illumination light 301 emitted from the light source 31. The reflection surfaces 350 of the plurality of concave mirrors constituting the annular mirror array 35 are all directed in different directions.

FIG. 16 is a conceptual diagram of the bottom plate 312 when viewed from above. The spatial light modulator 32 and the annular relay mirror 34 are disposed on the upper face of the bottom plate 312. The spatial light modulator 32 is disposed at the central portion of the upper face of the bottom plate 312. The annular relay mirror 34 is disposed in such a way as to surround the periphery of the spatial light modulator 32. The annular relay mirror 34 is an annular plane mirror.

The light source 31 has a configuration similar to that of the light source 11 of the first example embodiment. The light source 31 emits the illumination light 301. The emission face of the light source 31 is directed to a modulation part 320 of the spatial light modulator 32 via the through hole T of the top plate 311. The light source 31 may be disposed inside the through hole T. The light source 31 may be disposed on the lower face of the top plate 311 or between the top plate 311 and the spatial light modulator 32. In this case, the through hole T may not be formed in the top plate 311. The illumination light 301 emitted from the light source 31 passes through the through hole T and the modulation part 320 of the spatial light modulator 32 is irradiated with the illumination light.

The spatial light modulator 32 has a configuration similar to that of the spatial light modulator 12 of the first example embodiment. The spatial light modulator 32 is a phase modulation type spatial light modulator. The spatial light modulator 32 includes the modulation part 320. A plurality of modulation regions is set in the modulation part 320. A pattern (also referred to as a phase image) related to the image displayed by projection light 305 is set in each of the plurality of modulation regions under the control of the communication controller 39. Each of the plurality of modulation regions is irradiated with the illumination light 301 derived from laser light emitted from an emitter associated with the modulation region. The illumination light 301 incident on each of the plurality of modulation regions set in the modulation part 320 is modulated according to a pattern (phase image) set in each of the plurality of modulation regions. The modulated light 302 modulated in each of the plurality of modulation regions travels toward a reflection surface 330 of the relay mirror 33.

The relay mirror 33 is a plane mirror formed in a disk shape with the center point of the top plate 311 as the center. The reflection surface 330 of the relay mirror 33 faces the upper face of the bottom plate 312 disposed below. The relay mirror 33 is disposed concentrically with the annular mirror array 35. The relay mirror 33 is disposed at the inner side of the annular mirror array 35. The reflection surface 330 of the relay mirror 33 is irradiated with the modulated light 302 modulated by the modulation part 320 of the spatial light modulator 32. The modulated light 302 with which the reflection surface 330 of the relay mirror 33 is irradiated is reflected by the reflection surface 330 and travels toward a reflection surface 340 of the annular relay mirror 34.

The annular relay mirror 34 is a plane mirror formed in an annular shape with the center point of the bottom plate 312 as the center. The reflection surface 340 of the annular relay mirror 34 faces the lower face of the top plate 311 disposed above. The reflection surface 340 of the annular relay mirror 34 is irradiated with modulated light 302 reflected by the reflection surface 330 of the relay mirror 33. The modulated light 302 with which the reflection surface 340 of the annular relay mirror 34 is irradiated is reflected by the reflection surface 340 and travels toward the reflection surface 350 of the annular mirror array 35.

The annular mirror array 35 has a configuration similar to that of the annular mirror array 15 of the first example embodiment. The annular mirror array 35 has a configuration in which a plurality of concave mirrors is disposed in an annular shape. The reflection surface 350 of the concave mirror is formed of a free-form surface. Arranging a plurality of concave mirrors in an annular shape can cover a wide in a smaller number range than arranging a plurality of plane mirrors in an annular shape. The eight concave mirrors constituting the annular mirror array 35 are annularly disposed with their reflection surfaces 350 facing obliquely downward. The number of concave mirrors constituting the annular mirror array 35 is not limited to 8.

The modulated light 302 with which the reflection surface 350 of the annular mirror array 35 is irradiated is reflected by the reflection surface 350. The light (projection light 305) reflected by the reflection surface 350 is projected as a spatial optical signal. The reflection surface 350 of the annular mirror array 35 is directed in a 360 degree orientation in the horizontal plane. Therefore, the transmission device 3 can project the projection light 305 in a 360 degree orientation in the horizontal plane by controlling the pattern (phase image) set in the modulation part 320 of the spatial light modulator 32. The projection light 305 is projected in a direction along the horizontal plane. The traveling axis of the projection light 305 may be along the horizontal plane and may not be completely parallel to the horizontal plane.

The communication controller 39 has a configuration similar to that of the communication controller 19 of the first example embodiment. The communication controller 39 controls the light source 31 and the spatial light modulator 32. For example, the communication controller 39 is achieved by a microcomputer including a processor and a memory. The communication controller 39 sets a phase image related to the image to be projected in the modulation part 320. The communication controller 39 sets a phase image related to the image to be projected in the modulation region set in the modulation part 320 of the spatial light modulator 32. The phase image of the image to be projected may be stored in advance in a storage unit (not illustrated). The shape and the size of the image to be projected are not particularly limited.

The communication controller 39 controls the spatial light modulator 32 in such a way that a parameter that determines a difference between a phase of the illumination light 301 with which the modulation part 320 is irradiated and a phase of the modulated light 302 reflected by the modulation part 320 changes. The driving method of the spatial light modulator 32 by the communication controller 39 is determined according to the modulation scheme of the spatial light modulator 32. The communication controller 39 drives the light source 31 in a state in which the phase image related to the image to be displayed is set in the modulation part 320 of the spatial light modulator 32. As a result, in a state in which the phase image is set in the modulation part 320, the modulation part 320 is irradiated with the illumination light 301 emitted from light source 31. The illumination light 301 with which the modulation part 320 is irradiated is modulated by the modulation part 320.

The communication controller 39 modulates the illumination light 301 emitted from the light source 31 for communication with a communication target (not illustrated). In communication, the communication controller 39 controls the timing at which the illumination light 301 is emitted from the light source 31 in a state where the communication phase image is set in the modulation part 320 of the spatial light modulator 32. By such control, the illumination light 301 is modulated. The modulation pattern of the illumination light 301 in the communication is set in any pattern.

As described above, the transmission device of the present example embodiment includes the light source, the spatial light modulator, the relay mirror, the annular relay mirror, the annular mirror array, and the communication controller. The light source emits illumination light. The spatial light modulator includes the modulation part that is irradiated with the illumination light emitted from the light source. The relay mirror is disposed in the optical path of the modulated light emitted from the modulation part of the spatial light modulator. The relay mirror is disposed at a position where the modulated light is relay-reflected toward the reflection surface of the annular mirror array. The relay mirror has a planar reflection surface that relay-reflects the modulated light toward the reflection surface of the annular mirror array. The annular relay mirror is disposed in the optical path of the modulated light reflected by the reflection surface of the relay mirror. The annular relay mirror has a planar reflection surface that relay-reflects the modulated light as a spatial optical signal toward the reflection surface of the annular mirror array. The annular mirror array includes a plurality of concave mirrors annularly disposed around the optical axis of the illumination light. The annular mirror array is disposed at a position at which the modulated light relay-reflected by the reflection surface of the annular relay mirror is reflected laterally. The communication controller sets a phase image used for spatial optical communication in the modulation part of the spatial light modulator. The communication controller controls the light source in such a way that the modulation part to which the phase image is set is irradiated with the illumination light.

The transmission device of the present example embodiment reflects the modulated light modulated by the modulation part of the spatial light modulator toward the reflection surface of the concave mirror constituting the annular mirror array via the relay mirror and the reflection surface of the annular relay mirror. According to the transmission device of the present example embodiment, by repeatedly reflecting the modulated light by the relay mirror and the annular relay mirror, the angle formed by the vertical axis with respect to the modulation part of the spatial light modulator and the modulated light can be reduced even when the annular relay mirror is made larger than that in the second example embodiment. Therefore, according to the present aspect, the irradiation position accuracy of the spatial optical signal can be improved without increasing the size of the device, as compared with the second example embodiment.

### Fourth Example Embodiment

Next, the transmission device according to a fourth example embodiment will be described with reference to the drawings. A transmission device of the present example embodiment is different from the transmission devices of the first to third example embodiments in that a relay mirror having a convex reflection surface that returns modulated light modulated by a modulation part of a spatial light modulator is included.

### Configuration

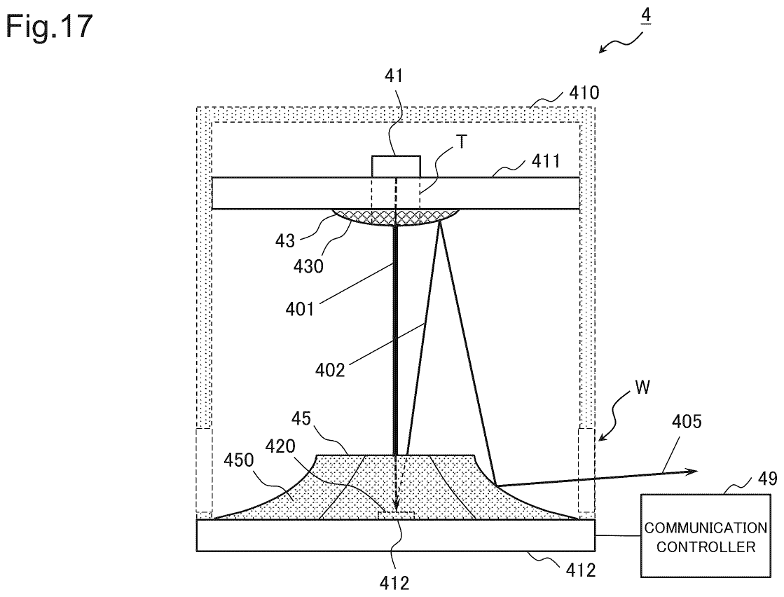

FIG. 17 to FIG. 19 are conceptual diagrams illustrating an example of a configuration of a transmission device in the present disclosure. A transmission device 4 includes a light source 41, a spatial light modulator 42, a relay mirror 43, an annular mirror array 45, and a communication controller 49. The light source 41, the spatial light modulator 42, the relay mirror 43, and the annular mirror array 45 constitute a transmitter. The transmitter is accommodated inside a housing 410 in which the window W for transmitting a spatial optical signal is formed.

FIG. 17 is a diagram of the internal configuration of the transmission device in the present disclosure when viewed from a side. FIG. 17 illustrates the housing 410 cut along a cutting line passing through the window W. FIG. 17 is conceptual, and does not accurately represent the shape of each component, the positional relationship between components, the travel of light, and the like. The configuration of FIG. 17 may be disposed in a state where the upper and lower sides are inverted. FIG. 17 illustrates a top plate 411 that supports the light source 41 and the relay mirror 43. FIG. 17 illustrates a bottom plate 412 on which the spatial light modulator 42 and the annular mirror array 45 are disposed.

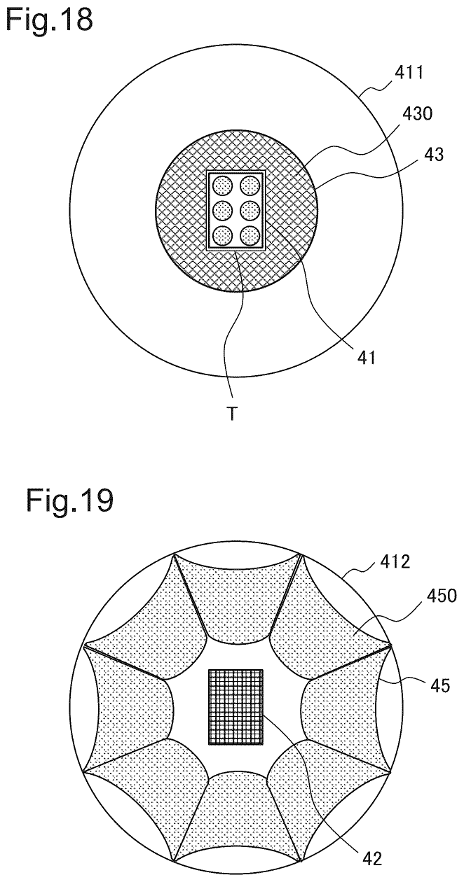

FIG. 18 is a conceptual diagram of the top plate of the transmission device in the present disclosure when viewed from below. The through hole T is opened at the center of the top plate 411. The through hole T is an opening for allowing illumination light 401 emitted from the light source 41 to pass downward. In the example of FIG. 18, the opening shape of the through hole Tis rectangular, but the opening shape of the through hole T may not be rectangular. The relay mirror 43 is disposed on a lower face of the top plate 411. The relay mirror 43 is a convex mirror having a convex reflection surface 430. For example, reflection surface 430 has a shape of part of a spherical surface. For example, the reflection surface 430 has a shape of part of a free-form surface.

FIG. 19 is a conceptual diagram of the bottom plate of the transmission device in the present disclosure when viewed from above. The spatial light modulator 42 and the annular mirror array 45 are disposed on the upper face of the bottom plate 412. The spatial light modulator 42 is disposed at the central portion of the upper face of the bottom plate 412. A modulation part 420 of the spatial light modulator 42 is directed to the light source 41. The annular mirror array 45 is disposed in such a way as to surround the periphery of the spatial light modulator 42. The annular mirror array 45 is a mirror array in which a plurality of concave mirrors is annularly disposed. The plurality of concave mirrors constituting the annular mirror array 45 is annularly disposed around the optical axis of the illumination light 401 emitted from the light source 41. The reflection surfaces 450 of the plurality of concave mirrors constituting the annular mirror array 45 are all directed in different directions.

The light source 41 has a configuration similar to that of the light source 11 of the first example embodiment. The light source 41 emits the illumination light 401. The emission face of the light source 41 is directed to a modulation part 420 of the spatial light modulator 42 via the through hole T of the top plate 411. The light source 41 may be disposed inside the through hole T. The light source 41 may be disposed on the lower face of the top plate 411 or between the top plate 411 and the spatial light modulator 42. In this case, the through hole T may not be formed in the top plate 411. The illumination light 401 emitted from the light source 41 passes through the through hole T and the modulation part 420 of the spatial light modulator 42 is irradiated with the illumination light.

The spatial light modulator 42 has a configuration similar to that of the spatial light modulator 12 of the first example embodiment. The spatial light modulator 42 is a phase modulation type spatial light modulator. The spatial light modulator 42 includes the modulation part 420. A plurality of modulation regions is set in the modulation part 420. A pattern (also referred to as a phase image) related to the image displayed by projection light 405 is set in each of the plurality of modulation regions under the control of the communication controller 49. Each of the plurality of modulation regions is irradiated with the illumination light 401 derived from laser light emitted from an emitter associated with the modulation region. The illumination light 401 incident on each of the plurality of modulation regions set in the modulation part 420 is modulated according to a pattern (phase image) set in each of the plurality of modulation regions. The modulated light 402 modulated in each of the plurality of modulation regions travels toward the reflection surface 430 of the relay mirror 43.

The relay mirror 43 is a convex mirror formed in a disk shape with the center point of the top plate 411 as the center. The through hole T is opened in the relay mirror 43. The reflection surface 430 of the relay mirror 43 faces the upper face of the bottom plate 412 disposed below. The reflection surface 430 of the relay mirror 43 is irradiated with the modulated light 402 modulated by the modulation part 420 of the spatial light modulator 42. The modulated light 402 with which the reflection surface 430 of the relay mirror 43 is irradiated is reflected by the reflection surface 450 and travels toward the reflection surface 450 of the annular mirror array 45.

The annular mirror array 45 has a configuration similar to that of the annular mirror array 15 of the first example embodiment. The annular mirror array 45 has a configuration in which a plurality of concave mirrors is disposed in an annular shape. The reflection surface 450 of the concave mirror is formed of a free-form surface. Arranging a plurality of concave mirrors in an annular shape can cover a wide in a smaller number range than arranging a plurality of plane mirrors in an annular shape. The eight concave mirrors constituting the annular mirror array 45 are annularly disposed with their reflection surfaces 450 facing obliquely downward. The number of concave mirrors constituting the annular mirror array 45 is not limited to 8.

The modulated light 402 with which the reflection surface 450 of the annular mirror array 45 is irradiated is reflected by the reflection surface 450. The light (projection light 405) reflected by the reflection surface 450 is projected as a spatial optical signal. The reflection surface 450 of the annular mirror array 45 is directed in a 360 degree orientation in the horizontal plane. Therefore, the transmission device 4 can project the projection light 405 in a 360 degree orientation in the horizontal plane by controlling the pattern (phase image) set in the modulation part 420 of the spatial light modulator 42. The projection light 405 is projected in a direction along the horizontal plane. The traveling axis of the projection light 405 may be along the horizontal plane and may not be completely parallel to the horizontal plane.

The communication controller 49 has a configuration similar to that of the communication controller 19 of the first example embodiment. The communication controller 49 controls the light source 41 and the spatial light modulator 42. For example, the communication controller 49 is achieved by a microcomputer including a processor and a memory. The communication controller 49 sets a phase image related to the image to be projected in the modulation part 420. The communication controller 49 sets a phase image related to the image to be projected in the modulation region set in the modulation part 420 of the spatial light modulator 42. The phase image of the image to be projected may be stored in advance in a storage unit (not illustrated). The shape and the size of the image to be projected are not particularly limited.

The communication controller 49 controls the spatial light modulator 42 in such a way that a parameter that determines a difference between a phase of the illumination light 401 with which the modulation part 420 is irradiated and a phase of the modulated light 402 reflected by the modulation part 420 changes. The driving method of the spatial light modulator 42 by the communication controller 49 is determined according to the modulation scheme of the spatial light modulator 42. The communication controller 49 drives the light source 41 in a state in which the phase image related to the image to be displayed is set in the modulation part 420 of the spatial light modulator 42. As a result, in a state in which the phase image is set in the modulation part 420, the modulation part 420 is irradiated with the illumination light 401 emitted from light source 41. The illumination light 401 with which the modulation part 420 is irradiated is modulated by the modulation part 420.

The communication controller 49 modulates the illumination light 401 emitted from the light source 41 for communication with a communication target (not illustrated). In communication, the communication controller 49 controls the timing at which the illumination light 401 is emitted from the light source 41 in a state where the communication phase image is set in the modulation part 420 of the spatial light modulator 42. By such control, the illumination light 401 is modulated. The modulation pattern of the illumination light 401 in the communication is set in any pattern.

As described above, the transmission device of the present example embodiment includes the light source, the spatial light modulator, the relay mirror, the annular mirror array, and the communication controller. The light source emits illumination light. The spatial light modulator includes the modulation part that is irradiated with the illumination light emitted from the light source. The relay mirror is disposed in the optical path of the modulated light emitted from the modulation part of the spatial light modulator. The relay mirror has a convex reflection surface that relay-reflects the modulated light toward the annular mirror array. The annular mirror array includes a plurality of concave mirrors annularly disposed around the optical axis of the illumination light. The annular mirror array is disposed at a position at which the modulated light relay-reflected by the reflection surface of the relay mirror is reflected laterally as a spatial optical signal. The communication controller sets a phase image used for spatial optical communication in the modulation part of the spatial light modulator. The communication controller controls the light source in such a way that the modulation part to which the phase image is set is irradiated with the illumination light.

The transmission device of the present example embodiment reflects the modulated light modulated by the modulation part of the spatial light modulator toward the reflection surface of the concave mirror constituting the annular mirror array via the reflection surface of the relay mirror having the convex reflection surface. According to the transmission device of the present example embodiment, the reflection angle is increased by the relay mirror having the convex reflection surface, whereby the reflection surface of the concave mirror constituting the annular mirror array can be increased. According to the transmission device of the present example embodiment, the modulated light is repeatedly reflected by the relay mirror having the convex reflection surface, so that the angle formed by the vertical axis with respect to the modulation part of the spatial light modulator and the modulated light can be reduced even when the annular relay mirror is enlarged, as in the third example embodiment. According to the transmission device of the present example embodiment, the effect similar to that of the third example embodiment can be obtained by one relay mirror. Therefore, according to the present aspect, the device can be simplified, as compared with the third example embodiment.

### Fifth Example Embodiment

Next, a communication device according to the fifth example embodiment will be described with reference to the drawings. The communication device of the present example embodiment has a configuration in which a transmission device and a reception device are combined. The transmission device has the configuration of any of the first to fourth example embodiments. The reception device is not particularly limited as long as it can receive the spatial optical signal. Hereinafter, an example of a reception device having a light receiving function including a ball lens will be described. The communication device of the present example embodiment may include a reception device having another light receiving function instead of the light receiving function including the ball lens.

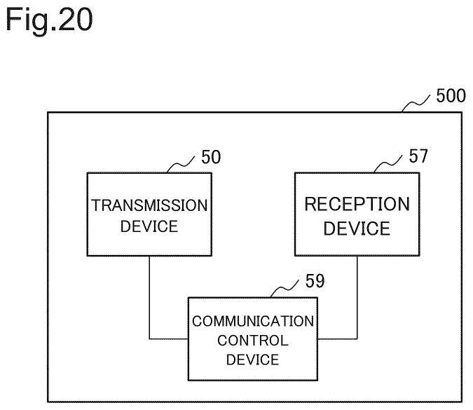

FIG. 20 is a conceptual diagram illustrating an example of a configuration of a communication device in the present disclosure. A communication device 500 includes a transmission device 50, a reception device 57, and a communication control device 59. The communication device 500 transmits and receives spatial optical signals to and from an external communication target. Therefore, an opening or a window for transmitting and receiving a spatial optical signal is formed in the communication device 500.

The transmission device 50 is any one of the transmission devices of the first to fourth example embodiments. The transmission device 50 acquires a control signal from the communication control device 59. The transmission device 50 projects a spatial optical signal according to the control signal. The spatial optical signal projected from the transmission device 50 is received by a communication target (not illustrated) of a transmission destination of the spatial optical signal.

The reception device 57 receives a spatial optical signal transmitted from a communication target (not illustrated). The reception device 57 converts the received spatial optical signal into an electric signal. The reception device 57 outputs the converted electric signal to the communication control device 59. For example, the reception device 57 has a light receiving function including a ball lens. The reception device 57 may have a light receiving function that does not include a ball lens.

The communication control device 59 acquires a signal output from the reception device 57. The communication control device 59 performs a process according to the acquired signal. The process performed by the communication control device 59 is not particularly limited. The communication control device 59 outputs a control signal for transmitting an optical signal related to the performed process to the transmission device 50. For example, the communication control device 59 performs a process based on a predetermined condition according to information included in the signal received by the reception device 57. For example, the communication control device 59 performs a process designated by an administrator or the like of the communication device 500 according to information included in a signal received by the reception device 57.

### Receiver

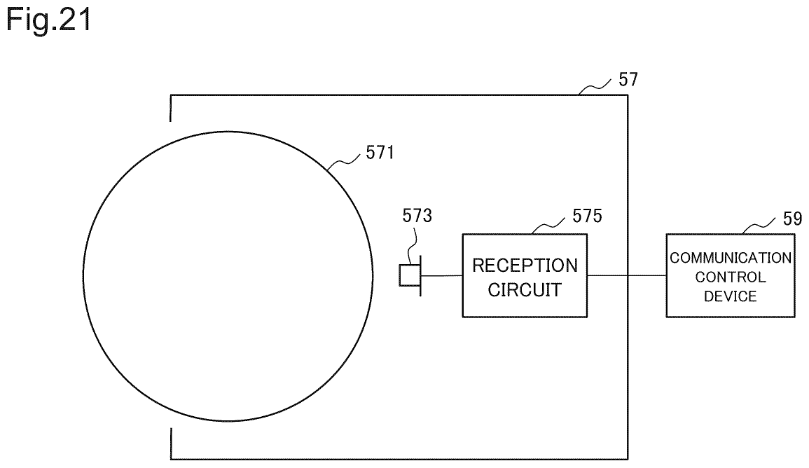

Next, a configuration of the reception device 57 will be described with reference to the drawings. FIG. 21 is a conceptual diagram for describing an example of a configuration of a receiver included in a communication device in the present disclosure. The reception device 57 includes a ball lens 571, a light receiving element 573, and a reception circuit 575. FIG. 21 is a side view of the internal configuration of the reception device 57 when viewed from a side. The position of the reception circuit 575 is not particularly limited. The reception circuit 575 may be disposed inside the reception device 57 or may be disposed outside the reception device 57. The function of the reception circuit 575 may be included in the communication control device 59.

The ball lens 571 is a spherical lens. The ball lens 571 is an optical element that collects a spatial optical signal transmitted from a communication target. The ball lens 571 has a spherical shape when viewed from an any angle. Part of the ball lens 571 protrudes from an opening opened in a housing of the reception device 57. The ball lens 571 collects the incident spatial optical signal. The spatial optical signal incident on the ball lens 571 protruding from the opening is condensed. As long as the spatial optical signal can be collected, part of the ball lens 571 may not protrude from the opening.

Light (optical signal) derived from the spatial optical signal condensed by the ball lens 571 is condensed toward the condensing region of the ball lens 571. Since the ball lens 571 has a spherical shape, the ball lens collects a spatial optical signal coming from an any direction. That is, the ball lens 571 exhibits similar light condensing performance for a spatial optical signal coming from an any direction. The light incident on the ball lens 571 is refracted when entering the ball lens 571. The light traveling inside the ball lens 571 is refracted again when being emitted to the outside of the ball lens 571. Most of the light emitted from the ball lens 571 is condensed in the condensing region.

For example, the ball lens 571 can be made of a material such as glass, crystal, or resin. In the case of receiving a spatial optical signal in the visible region, the ball lens 571 can be achieved by a material such as glass, crystal, or resin that transmits/refracts light in the visible region. For example, the ball lens 571 can be achieved by optical glass such as crown glass or flint glass. For example, the ball lens 571 can be achieved by a crown glass such as Boron Kron (BK). For example, the ball lens 571 can be achieved by a flint glass such as Lanthanum Schwerflint (LaSF). For example, quartz glass can be applied to the ball lens 571. For example, crystal such as sapphire can be applied to the ball lens 571. For example, transparent resin such as acrylic can be applied to the ball lens 571.

In a case where the spatial optical signal is light in a near-infrared region (hereinafter, also referred to as near infrared rays), a material that transmits near infrared rays is used for the ball lens 571. For example, in a case of receiving a spatial optical signal in a near-infrared region of about 1.5 micrometers (μm), a material such as silicon can be applied to the ball lens 571 in addition to glass, crystal, resin, and the like. In a case where the spatial optical signal is light in an infrared region (hereinafter, infrared rays), a material that transmits infrared rays is used for the ball lens 571. For example, in a case where the spatial optical signal is an infrared ray, silicon, germanium, or a chalcogenide material can be applied to the ball lens 571. The material of the ball lens 571 is not limited as long as light in the wavelength region of the spatial optical signal can be transmitted/refracted. The material of the ball lens 571 may be appropriately selected according to the required refractive index and use.

The ball lens 571 may be replaced with another condenser as long as the spatial optical signal can be collected toward the region where the light receiving element 573 is disposed. For example, the ball lens 571 may be a light beam control element that guides the incident spatial optical signal toward the light reception unit of the light receiving element 573. For example, the ball lens 571 may have a configuration in which a lens or a light beam control element is combined. For example, a configuration for guiding the optical signal condensed by the ball lens 571 toward the light reception unit of the light receiving element 573 may be added.

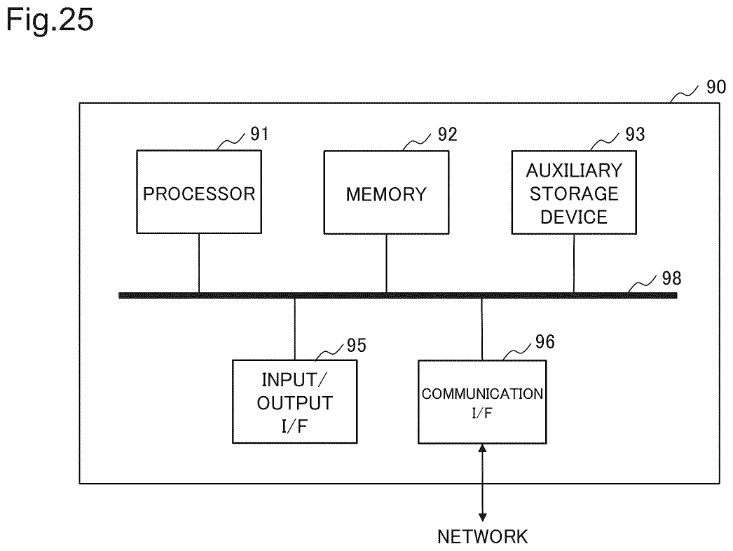

The light receiving element 573 is disposed at a stage subsequent to the ball lens 571. The light receiving element 573 is disposed in the condensing region of the ball lens 571. The light receiving element 573 includes a light reception unit that receives the optical signal condensed by the ball lens 571. The optical signal condensed by the ball lens 571 is received by the light reception unit of the light receiving element 573. The light receiving element 573 converts the received optical signal into an electric signal (hereinafter, also referred to as a signal). The light receiving element 573 outputs the converted signal to the reception circuit 575. FIG. 25 illustrates an example in which the light receiving element 573 is a single element. For example, the plurality of light receiving elements 573 may be disposed in the condensing region of the ball lens 571. For example, a light receiving element array in which a plurality of light receiving elements 573 is arrayed may be disposed in the condensing region of the ball lens 571.

The light receiving element 573 receives light in a wavelength region of the spatial optical signal to be received. For example, the light receiving element 573 has sensitivity to light in the visible region. For example, the light receiving element 573 has sensitivity to light in an infrared region. The light receiving element 573 is sensitive to light having a wavelength in a 1.5 μm (micrometer) band, for example. The wavelength band of light to which the light receiving element 573 has sensitivity is not limited to the 1.5 μm band. The wavelength band of the light received by the light receiving element 573 can be set to any band in accordance with the wavelength of the spatial optical signal to be received. The wavelength band of the light received by the light receiving element 573 may be set to, for example, a 0.8 μm band, a 1.55 μm band, or a 2.2 μm band. The wavelength band of the light received by the light receiving element 573 may be, for example, a band of 0.8 to 1 μm. A shorter wavelength band is advantageous for optical spatial communication during rainfall because absorption by moisture in the atmosphere is small. When the light receiving element 573 is saturated with intense sunlight, the light receiving element cannot read the optical signal derived from the spatial optical signal. Therefore, a color filter that selectively passes the light of the wavelength band of the spatial optical signal may be installed before the light receiving element 573.

For example, the light receiving element 573 can be achieved by an element such as a photodiode or a phototransistor. For example, the light receiving element 573 is achieved by an avalanche photodiode. The light receiving element 573 achieved by the avalanche photodiode can support high speed communication. The light receiving element 573 may be achieved by an element other than a photodiode, a phototransistor, or an avalanche photodiode as long as an optical signal can be converted into an electric signal. In order to improve the communication speed, the light reception unit of the light receiving element 573 is preferably as small as possible. For example, the light reception unit of the light receiving element 573 has a square light receiving face having a side of about 5 mm (mm). For example, the light reception unit of the light receiving element 573 has a circular light receiving face having a diameter of about 0.1 to 0.3 mm. The size and shape of the light reception unit of the light receiving element 573 may be selected according to the wavelength band, the communication speed, and the like of the spatial optical signal.

For example, a polarizing filter (not illustrated) may be disposed before the light receiving element 573. The polarizing filter is disposed in association with the light reception unit of the light receiving element 573. For example, the polarizing filter is disposed to overlap the light reception unit of the light receiving element 573. For example, the polarizing filter may be selected according to the polarization state of the spatial optical signal to be received. For example, when the spatial optical signal to be received is linearly polarized light, the polarizing filter includes a ½ wave plate. For example, when the spatial optical signal to be received is circularly polarized light, the polarizing filter includes a ¼ wavelength plate. The polarization state of the optical signal having passed through the polarizing filter is converted according to the polarization characteristic of the polarizing filter.

The reception circuit 575 acquires a signal output from the light receiving element 573. The reception circuit 575 amplifies the signal from the light receiving element 573. The reception circuit 575 decodes the amplified signal. The signal decoded by the reception circuit 575 is used for any purpose. The use of the signal decoded by the reception circuit 575 is not particularly limited.

### Communication Device

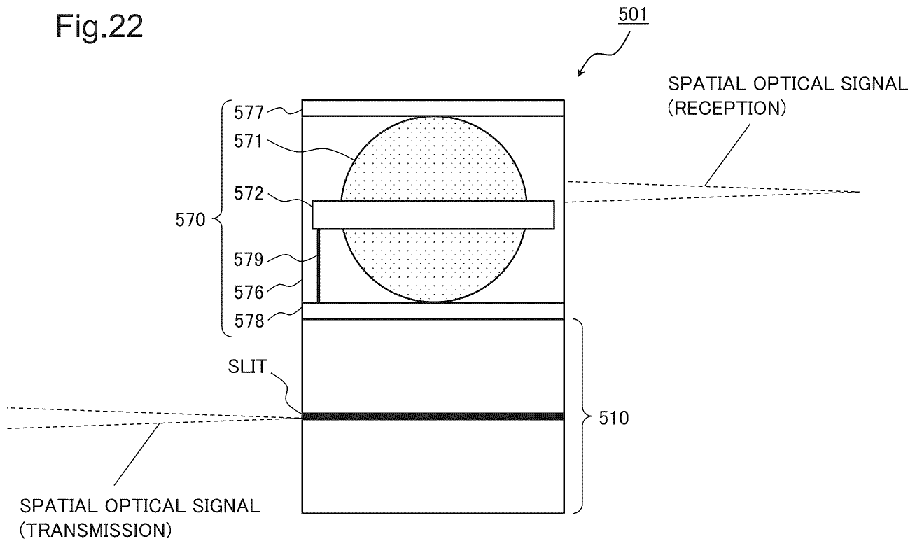

FIG. 22 is a conceptual diagram illustrating an example of a configuration of a communication device in the present disclosure. A communication device 501 includes a transmission device 510, a reception device 570, and a communication control device (not illustrated). In FIG. 22, a reception circuit and a communication control device are omitted. The reception circuit and the communication control device are disposed inside the communication device 501. The communication device 501 has a configuration in which the transmission device 510 having a cylindrical outer shape and the reception device 570 are combined.

The reception device 570 includes the ball lens 571, a light receiver 572, a window 576, a top plate 577, and a bottom plate 578. The ball lens 571 is sandwiched between the top plate 577 and the bottom plate 578. Since the upper and lower parts of the ball lens 571 are not used for transmission and reception of spatial optical signals, they may be processed into a planar shape in such a way as to be easily sandwiched between the top plate 577 and the bottom plate 578. The light receiver 572 is disposed in accordance with the condensing region of the ball lens 571 in such a way as to be able to receive the spatial optical signal to be received. The light receiver 572 includes a light receiving element array in which a plurality of light receiving elements is annularly disposed. The plurality of light receiving elements is disposed in the condensing region of the ball lens 571. The plurality of light receiving elements is disposed with the light reception unit facing the ball lens 571. The plurality of light receiving elements is connected to the communication control device and the transmission device 510 by conductive wiring 579.

The window 576 is disposed at a side face of the cylindrical reception device 570. The window 576 is made of a material that transmits a spatial optical signal used for communication. The window 576 functions as a filter that removes unnecessary light and selectively transmits a spatial optical signal used for communication. The top plate 577 is disposed on an upper face of the cylindrical reception device 570. The bottom plate 578 is disposed on a lower face of the cylindrical reception device 570. The top plate 577 and the bottom plate 578 sandwich the ball lens 571 from above and below. The light receiver 572 formed in an annular shape is disposed around the ball lens 571. The light receiver 572 includes a plurality of light receiving elements in which the light reception unit faces the ball lens 571. The spatial optical signal incident on the ball lens 571 through the window 576 is condensed toward the light receiver 572 by the ball lens 571. The optical signal condensed on the light receiver 572 is guided toward the light reception unit of any of the light receiving elements. The optical signal reaching the light reception unit of the light receiving element is received by the light receiving element. The communication control device (not illustrated) decodes an optical signal received by a light receiving element included in the light receiver 572. The communication control device causes the transmission device 510 to transmit the spatial optical signal according to the decoded optical signal.

The transmission device 510 is any of the transmission devices of the first to fourth example embodiments. The transmission device 510 is housed inside a cylindrical housing. A slit opened in accordance with the transmission direction of the spatial optical signal by the transmission device 510 is formed in the cylindrical housing. For example, in a case where the transmission device 510 can transmit a spatial optical signal in a 360 degree orientation, a slit is formed on the side face of the housing of the transmission device 510 in accordance with the transmission direction of the spatial optical signal.

### Application Example

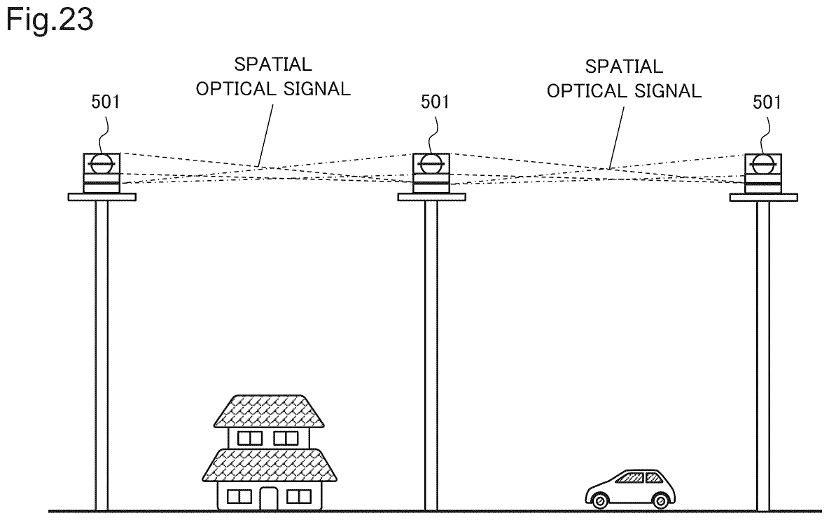

Next, the application example according to the present example embodiment will be described with reference to the drawings. In the following application example, an example in which a plurality of communication devices 501 transmits and receives spatial optical signals will be described. FIG. 23 is a conceptual diagram for describing an application example in the present disclosure. In the present application example, an example (communication system) of a communication network in which a plurality of communication devices 501 is disposed on an upper portion (space above a pole) of a pillar such as a utility pole or a street lamp disposed in a town will be described.

There are few obstacles in the space above the pillar. Therefore, the space above the pillar is suitable for installing the communication device 501. When the communication device 501 is installed at the same height, the incoming direction of the spatial optical signal is limited to the horizontal direction. Therefore, the light receiving area of the light receiver constituting the reception device 570 can be reduced, and the device can be simplified. The pair of communication devices 501 that transmit and receive the spatial optical signal is disposed in such a way that at least one communication device 501 receives the spatial optical signal transmitted from the other communication device 501. The pair of communication devices 501 may be disposed to transmit and receive spatial optical signals to and from each other. In a case where the communication network of the spatial optical signal is configured by the plurality of communication devices 501, the communication device 501 positioned in the middle may be disposed to relay the spatial optical signal transmitted from another communication device 501 to another communication device 501.

According to the present application example, communication using a spatial optical signal can be performed between the plurality of communication devices 501 each disposed in the space above the pillar. For example, communication by wireless communication may be performed between a wireless device or a base station installed in an automobile, a house, or the like and the communication device 501 according to communication between the communication devices 501. For example, the communication device 501 may be connected to the Internet via a communication cable or the like installed on a pillar.

As described above, the communication device according to the present example embodiment includes the reception device, the transmission device, and the communication control device. The transmission device is any one of the transmission devices according to the first to fourth example embodiments. The reception device receives the spatial optical signal transmitted from the communication target. The communication control device acquires a signal based on the spatial optical signal transmitted from the communication target received by the reception device. The communication control device performs a process according to the acquired signal. The communication control device causes the transmission device to transmit, to the communication target, a spatial optical signal related to the performed processing.

The transmission device included in the communication device according to the present example embodiment transmits a spatial optical signal that is hardly attenuated in an any direction along a horizontal plane. Therefore, the transmission device of the present example embodiment can transmit a spatial optical signal of stable intensity to a plurality of communication devices disposed in an any direction along the horizontal plane. That is, according to the present example embodiment, it is possible to continuously transmit a spatial optical signal for optical spatial communication to a communication device disposed in an any direction along a horizontal plane.

A communication system according to an aspect of the present example embodiment includes the plurality of above-described communication device. In the communication system, a plurality of communication devices is disposed at positions at which spatial optical signals are mutually transmitted and received. According to the present aspect, it is possible to achieve a communication network capable of achieving continuous transmission and reception of spatial optical signals.

### Sixth Example Embodiment

Next, the transmission device according to a sixth example embodiment will be described with reference to the drawings. The transmission device of the present example embodiment has a configuration in which the transmission devices of the first to fourth example embodiments are simplified. For example, the functions of the components included in the transmission device in the present example embodiment are implemented by the functions of the components included in the transmission device in the first to fourth example embodiments. The transmission device in the present example embodiment is controlled by the communication controllers in the first to fourth example embodiments. A control method by the communication controller will not be described.

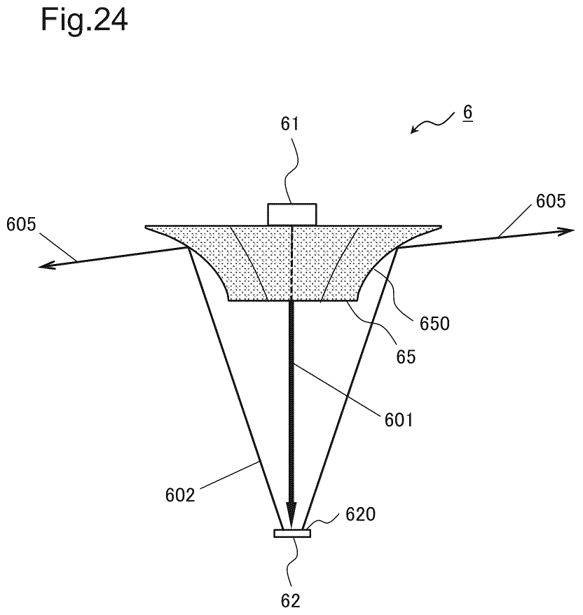

FIG. 24 is a conceptual diagram illustrating an example of a configuration of a transmission device in the present disclosure. A transmission device 6 includes a light source 61, a spatial light modulator 62, and an annular mirror array 65.

The light source 61 emits illumination light 601. The spatial light modulator 62 includes a modulation part 620 that is irradiated with the illumination light 601 emitted from the light source. The annular mirror array 65 includes a plurality of concave mirrors annularly disposed around the optical axis of the illumination light 601. The annular mirror array 65 is disposed at a position at which modulated light 602 modulated by the modulation part 620 of the spatial light modulator 62 is reflected laterally as projection light 605.

The transmission device of the present example embodiment includes an annular mirror array including a plurality of concave mirrors. Since the annular mirror array includes concave mirrors each having a reflection surface having a larger radius of curvature than an annular mirror constituted by one reflection surface, it is possible to suppress the spread of the projection angle in the horizontal plane. Since the annular mirror array includes concave mirrors each having a reflection surface having a large radius of curvature, it is possible to suppress the spread of the projection angle as compared with an annular mirror array including a plurality of plane mirrors. That is, according to the transmission device of the present example embodiment, it is possible to transmit a spatial optical signal that is hardly attenuated in an any direction along the horizontal plane.

### Hardware

Next, a hardware configuration that executes control and processing according to each example embodiment of the present disclosure will be described with reference to the drawings. An example of such a hardware configuration is an information processing device 90 (computer) in FIG. 25. The information processing device 90 in FIG. 25 is a configuration example for executing control and processing of each example embodiment, and does not limit the scope of the present disclosure.

As illustrated in FIG. 25, the information processing device 90 includes a processor 91, a main storage device 92, an auxiliary storage device 93, an input/output interface 95, and a communication interface 96. In FIG. 25, the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing control and processing of each example embodiment. The processor 91 executes the program developed in the main storage device 92. The processor 91 executes the program to execute control and process according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). As the main storage device 92, a nonvolatile memory such as a magneto resistive random access memory (MRAM) may be configured/added.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. As an interface connected to an external device, the input/output interface 95 and the communication interface 96 may be shared.

An input device such as a keyboard, a mouse, or a touch panel may be connected to the information processing device 90 as necessary. These input devices are used to input of information and settings. In a case where a touch panel is used as the input device, a screen having a touch panel function serves as an interface. The processor 91 and the input device are connected via the input/output interface 95.

The information processing device 90 may be provided with a display device that displays information. In a case where a display device is provided, the information processing device 90 includes a display control device (not illustrated) that controls display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling control and processing according to each example embodiment of the present disclosure. The hardware configuration of FIG. 25 is an example of a hardware configuration that executes control and processing according to each example embodiment, and does not limit the scope of the present disclosure. A program for causing a computer to execute control and processing according to each example embodiment is also included in the scope of the present disclosure.

A program recording medium in which the program according to each example embodiment is recorded is also included in the scope of the present disclosure. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium. In a case where the program executed by the processor is recorded in the recording medium, the recording medium is a program recording medium.

The components of each example embodiment may be combined in any manner. The components of each example embodiment may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all of the above example embodiments may be described as the following Supplementary Notes, but are not limited to the following.

### Supplementary Note 1

A transmission device including
a light source that emits illumination light,
a spatial light modulator including a modulation part irradiated with the illumination light emitted from the light source, and
an annular mirror array including a plurality of concave mirrors annularly disposed with an optical axis of the illumination light as a center, and disposed at a position at which modulated light modulated by the modulation part of the spatial light modulator is reflected laterally as a spatial optical signal.

### Supplementary Note 2

The transmission device according to Supplementary Note 1, further including
a relay mirror disposed in an optical path of the modulated light emitted from the modulation part of the spatial light modulator and having a planar reflection surface that relay-reflects the modulated light toward the annular mirror array, wherein
the annular mirror array
is disposed at a position at which the modulated light relay-reflected by the reflection surface of the relay mirror is reflected laterally.

### Supplementary Note 3

The transmission device according to Supplementary Note 2, further including
an annular relay mirror disposed in an optical path of the modulated light reflected by a reflection surface of the relay mirror and having a planar reflection surface that relay-reflects the modulated light toward the annular mirror array, wherein
the annular mirror array
is disposed at a position at which the modulated light relay-reflected by the reflection surface of the annular relay mirror is reflected laterally.

### Supplementary Note 4

The transmission device according to Supplementary Note 1, further including
a relay mirror disposed in an optical path of the modulated light emitted from the modulation part of the spatial light modulator and having a convex reflection surface that relay-reflects the modulated light toward a reflection surface of the annular mirror array, wherein
the annular mirror array
is disposed at a position at which the modulated light relay-reflected by the reflection surface of the relay mirror is reflected laterally.

### Supplementary Note 5

The transmission device according to Supplementary Note 1, further including a communication controller that sets a phase image used for spatial optical communication in the modulation part of the spatial light modulator, and controls the light source in such a way that the modulation part in which the phase image is set is irradiated with the illumination light.

### Supplementary Note 6

The transmission device according to Supplementary Note 5, wherein
the light source includes a plurality of emitters, and
the communication controller
sets a plurality of modulation regions in the modulation part of the spatial light modulator in association with the plurality of emitters, and
sets, in a mode for searching for a communication target, a phase image in which a single concave mirror among the plurality of concave mirrors constituting the annular mirror array is irradiated with the modulated light modulated in the plurality of modulation regions in the modulation part of the spatial light modulator.

### Supplementary Note 7

The transmission device according to Supplementary Note 6, wherein
in a mode for communicating with the communication target, the communication controller
associates each of the plurality of concave mirrors constituting the annular mirror array with any of the plurality of communication targets, and sets a phase image in which each of the concave mirrors associated with any of the plurality of communication targets is irradiated with modulated light modulated in any of the plurality of modulation regions in the modulation part of the spatial light modulator.

### Supplementary Note 8

The transmission device according to Supplementary Note 6, wherein
in a mode for communicating with the communication target, the communication controller
associates at least any one of the plurality of concave mirrors constituting the annular mirror array with a single communication target, and sets a phase image in which a concave mirror associated with the single communication target is irradiated with modulated light modulated in the plurality of modulation regions in the modulation part of the spatial light modulator.

### Supplementary Note 9

The transmission device according to Supplementary Note 5, further including
a photodetector disposed at a side of any of a plurality of concave mirrors constituting the annular mirror array, wherein
the communication controller
sets, in an optical power measuring mode, a phase image in which the photodetector is irradiated with the modulated light modulated by the modulation part of the spatial light modulator in the spatial light modulator,
measures optical power of the modulated light detected by the photodetector, and
adjusts an output of the light source according to the measured optical power of the modulated light.

### Supplementary Note 10

A communication device including
the transmission device according to any one of Supplementary Notes 1 to 9,
a reception device that receives a spatial optical signal transmitted from a communication target, and
a communication control device that acquires a signal based on the spatial optical signal transmitted from the communication target, the spatial optical signal being received by the reception device, executes a process according to the acquired signal, and causes the transmission device to transmit a spatial optical signal according to the executed process toward the communication target.

1. A transmission device comprising:
a light source that emits illumination light;
a spatial light modulator including a modulation part irradiated with the illumination light emitted from the light source; and
an annular mirror array including a plurality of concave mirrors annularly disposed with an optical axis of the illumination light as a center, and disposed at a position at which modulated light modulated by the modulation part of the spatial light modulator is reflected laterally as a spatial optical signal.

2. The transmission device according to claim 1, further comprising:
a relay mirror disposed in an optical path of the modulated light emitted from the modulation part of the spatial light modulator and having a planar reflection surface that relay-reflects the modulated light toward the annular mirror array, wherein
the annular mirror array is disposed at a position at which the modulated light relay-reflected by the reflection surface of the relay mirror is reflected laterally.

3. The transmission device according to claim 2, further comprising:
an annular relay mirror disposed in an optical path of the modulated light reflected by a reflection surface of the relay mirror and having a planar reflection surface that relay-reflects the modulated light toward the annular mirror array, wherein
the annular mirror array is disposed at a position at which the modulated light relay-reflected by the reflection surface of the annular relay mirror is reflected laterally.

4. The transmission device according to claim 1, further comprising:
a relay mirror disposed in an optical path of the modulated light emitted from the modulation part of the spatial light modulator and having a convex reflection surface that relay-reflects the modulated light toward a reflection surface of the annular mirror array, wherein
the annular mirror array is disposed at a position at which the modulated light relay-reflected by the reflection surface of the relay mirror is reflected laterally.

5. The transmission device according to claim 1, further comprising:
a communication controller that comprises
a memory storing instructions; and
a processor connected to the memory and configured to execute the instructions to
set a phase image used for spatial optical communication in the modulation part of the spatial light modulator, and
control the light source in such a way that the modulation part in which the phase image is set is irradiated with the illumination light.

6. The transmission device according to claim 5, wherein
the light source includes a plurality of emitters, and
the processor of the communication controller is configured to execute the instructions to
set a plurality of modulation regions in the modulation part of the spatial light modulator in association with the plurality of emitters, and
in a mode for searching for a communication target, set a phase image in which a single concave mirror among the plurality of concave mirrors constituting the annular mirror array is irradiated with the modulated light modulated in the plurality of modulation regions in the modulation part of the spatial light modulator.

7. The transmission device according to claim 6, wherein
in a mode for communicating with the communication target, the processor of the communication controller is configured to execute the instructions to
associate each of the plurality of concave mirrors constituting the annular mirror array with any of the plurality of communication targets, and
set a phase image in which each of the concave mirrors associated with any of the plurality of communication targets is irradiated with modulated light modulated in any of the plurality of modulation regions in the modulation part of the spatial light modulator.

8. The transmission device according to claim 6, wherein
in a mode for communicating with the communication target, the processor of the communication controller is configured to execute the instructions to
associate at least any one of the plurality of concave mirrors constituting the annular mirror array with a single communication target, and
set a phase image in which a concave mirror associated with the single communication target is irradiated with modulated light modulated in the plurality of modulation regions in the modulation part of the spatial light modulator.

9. The transmission device according to claim 5, further comprising:
a photodetector disposed at a side of any of a plurality of concave mirrors constituting the annular mirror array, wherein
in an optical power measuring mode, the processor of the communication controller is configured to execute the instructions to
set a phase image in which the photodetector is irradiated with the modulated light modulated by the modulation part of the spatial light modulator in the spatial light modulator,
measure optical power of the modulated light detected by the photodetector, and
adjust an output of the light source according to the measured optical power of the modulated light.

10. A communication device comprising:
the transmission device according to claim 1;
a reception device that receives a spatial optical signal transmitted from a communication target; and
a communication control device that acquires a signal based on the spatial optical signal transmitted from the communication target, the spatial optical signal being received by the reception device, executes a process according to the acquired signal, and causes the transmission device to transmit a spatial optical signal according to the executed process toward the communication target.
